(19) United States
(12) Patent Application Publication
(10) Pub. No.: US 2008/0176013 A1
(43) Pub. Date: Jul. 24, 2008

(54) HONEYCOMB STRUCTURE, METHOD FOR MANUFACTURING THE SAME, AND CASING

(75) Inventors: Kazushige Ohno, Ibi-gun (JP); Tomokazu Oya, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/951,927

(22) Filed: Dec. 6, 2007

Related U.S. Application Data
(63) Continuation of application No. PCT/JP2006/326282, filed on Dec. 28, 2006.

(30) Foreign Application Priority Data
Apr. 20, 2006 (JP) 2006-117043

(51) Int. Cl. B32B 1/08; B32B 37/14; B32B 3/12

(52) U.S. Cl. 428/34.1; 428/116; 156/60

(57) ABSTRACT

A pillar-shaped honeycomb structure having a plurality of cells formed by laminating a plurality of lamination members with a plurality of through holes. The plurality of through holes form the plurality of cells. The lamination members are a substantially disc shaped. A plane portion, a protruding portion, or a cut-out portion is formed on a peripheral side face of the lamination member, or a rod member is inserted in at least one cell of the plurality of cells, where the rod member penetrates from one end to the other end of the cell.

### CROSS-REFERENCE TO RELATED APPLICATIONS

This application is a continuation application of PCT/JP2006/326282 filed on Dec. 28, 2006, which claims priority of Japanese Patent Application No. 2006-117043 filed on Apr. 20, 2006. The contents of these applications are incorporated herein by reference in their entirety.

### BACKGROUND OF THE INVENTION

1. Field of the Invention

The present invention relates to structures for purifying or converting gases, and methods of manufacturing such structures.

2. Discussion of the Background

PMs (particulate matters) such as soot are contained in exhaust gases discharged from an internal combustion engine such as a diesel engine, and in recent years, these PMs have raised serious problems as contaminants harmful to the environment and the human body.

For this reason, various ceramic honeycomb filters made from cordierite, silicon carbide or the like have been proposed as filters that collect PMs in exhaust gases to purify the exhaust gases. Moreover, there have been proposed various filters using a honeycomb structure manufactured by laminating lamination members having through holes (for example, see WO 2005/000445A1). Here, the following description will discuss a filter using a honeycomb structure manufactured by laminating lamination members having through holes.

FIG. 1A is a perspective view that schematically shows a specific example of a lamination-type honeycomb structure which is formed by laminating disc-shaped lamination members including inorganic fiber aggregated body with through holes, and FIG. 1B is a cross-sectional view taken along the line A-A of FIG. 1A.

A honeycomb structure 100 has a cylindrical shaped structure in which a number of cells 111 each having either one of the ends sealed are longitudinally placed in parallel with one another with a wall portion 113 therebetween. In other words, as shown in FIG. 1B, each cell 111 has either one of the ends corresponding to the inlet side or the outlet side of exhaust gases sealed, so that exhaust gases, introduced into one cell 111, are allowed to flow out from another cell 111, after always having passed through the cell wall 113 separating the cells 111; thus, the cell wall 113 is allowed to function as a filter.

Here, the honeycomb structure 100 is prepared as a lamination body formed by laminating lamination members 110a having a sheet shape with a thickness of 0.1 to 20 mm, and the lamination members 110a are laminated in such a manner that the through holes are superposed on one another in the longitudinal direction to form cells.

FIG. 2A is a perspective view that shows lamination members that form a honeycomb structure, and FIG. 2B is a perspective view that shows a state in which the lamination members shown in FIG. 2A are laminated to manufacture a honeycomb structure.

In order to form the respective lamination members into a lamination body, the lamination members 110a are laminated inside a casing 123 (metal can-type body) to be attached to an exhaust-gas pipe, and a lamination member 110b for an end portion with through holes formed in a grid pattern is added to an end portion, with a pressure applied thereto. Thus, a honeycomb structure is formed.

When an exhaust-gas purifying filter including a honeycomb structure having the above-mentioned structure is installed in an exhaust passage of an internal combustion engine, PMs in exhaust gases discharged from the internal combustion engine are captured by the wall portions 113 while passing through this honeycomb structure so that the exhaust gases are purified.

The contents of WO 2005/000445A1 are incorporated herein by reference in their entirety.

### SUMMARY OF THE INVENTION

A honeycomb structure in accordance with a first aspect of the present invention is a pillar-shaped honeycomb structure having a plurality of cells formed by laminating a plurality of lamination members with a plurality of through holes, the plurality of through holes forming the plurality of cells, wherein the lamination member has an almost disc shape, and a plane portion, a protruding portion, or a cut-out portion is formed on a peripheral side face of the lamination member, or a rod member is inserted in at least one cell of the plurality of cells, the rod member penetrating from one of the ends to the other end of the cell.

In the honeycomb structure in accordance with the first aspect of the present invention, the plurality of lamination members with the cut-out portion on the peripheral side face are preferably laminated so that the cut-out portions are laminated with one another, and a cut-out filling member having an almost the same shape as that of the laminated cut-out portions is preferably inserted to fit into the laminated cut-out portions.

The plurality of lamination members preferably include at least one of a lamination member mainly including inorganic fibers and a lamination member mainly comprising metal.

A material for the lamination member mainly including inorganic fibers is preferably silica-alumina, mullite, alumina, silica, titania, zirconia, silicon nitride, boron nitride, silicon carbide, or basalt.

The inorganic fibers are preferably firmly fixed with one another by an inorganic substance containing silica in the lamination member mainly including inorganic fibers, and the inorganic fibers are preferably firmly fixed with one another at crossing points of the inorganic fibers or neighborhood of the points.

A material for the lamination member mainly including metal is preferably chrome-based stainless steel or chrome-nickel-based stainless steel.

A lamination member for an end portion having through holes formed in a grid pattern is preferably laminated onto each of two ends of at least one of the lamination member mainly including inorganic fibers and the lamination member mainly including metal.

In the honeycomb structure in accordance with the first aspect of the present invention, a catalyst is preferably supported on the lamination member.

The protruding portion or the cut-out portion preferably has an almost semicircular shape, an almost triangular shape or an almost quadrilateral shape.

A honeycomb structure in accordance with a second aspect of the present invention includes: a cylindrical lamination body formed by laminating a plurality of lamination members each having a plurality of through holes; and an insertion member placed in parallel with a longitudinal direction of the cylindrical lamination body so as to divide the cylindrical lamination body, wherein the lamination member has the same divided disc shape as the cross section perpendicular to the longitudinal direction of the cylindrical lamination body that is divided by the insertion member, a side face plane portion of the laminated lamination members is placed so as to contact to the insertion member, and the plurality of through holes are connected to one another to form a plurality of cells.

The plurality of lamination members preferably include at least one of a lamination member mainly including inorganic fibers and a lamination member mainly including metal.

A material for the lamination member mainly including inorganic fibers is silica-alumina, mullite, alumina, silica, titania, zirconia, silicon nitride, boron nitride, silicon carbide, or basalt.

The inorganic fibers are preferably firmly fixed with one another by an inorganic substance containing silica in the lamination member mainly including inorganic fibers, and the inorganic fibers are preferably firmly fixed with one another at crossing points of the inorganic fibers or neighborhood of the points.

A material for the lamination member mainly including metal is preferably chrome-based stainless steel or chrome-nickel-based stainless steel.

A lamination member for an end portion having through holes formed in a grid pattern is preferably laminated onto each of two ends of at least one of the lamination member mainly including inorganic fibers and the lamination member mainly including metal.

In the honeycomb structure in accordance with the second aspect of the present invention, a catalyst is preferably supported on the lamination member.

A casing in accordance with a third aspect of the present invention is a casing for an exhaust-gas purifying apparatus used for covering a honeycomb structure, wherein a plane portion, a groove portion, or a protruding portion is formed at a region where the lamination members are laminated.

In the casing in accordance with the third aspect of the present invention, the groove portion or the protruding portion preferably has an almost semicircular shape, an almost triangular shape or an almost quadrilateral shape.

A method for manufacturing a honeycomb structure in accordance with a fourth aspect of the present invention includes: laminating a plurality of lamination members so that a plane portion formed on a peripheral side face of the lamination members is mounted on a plane portion formed on a casing; laminating a plurality of lamination members so that a protruding portion formed in a peripheral side face of the lamination members is fitted into a groove portion formed in a casing; laminating a plurality of lamination members so that a cut-out portion formed in a peripheral side face of the lamination members is fitted to a protruding portion formed in a casing; laminating a plurality of lamination members in a manner so as to allow a cut-out filling member to be inserted to fit into a cut-out portions formed in a peripheral side face of the lamination members; or adjusting a position of through holes by inserting a rod member into at least one of the through holes before or after laminating lamination members.

The method for manufacturing the honeycomb structure which includes adjusting a position of the through holes by inserting a rod member into at least one of the through holes before or after laminating the lamination members in accordance with the fourth aspect of the present invention preferably further includes: applying a pressure onto the lamination members in which the rod member has been inserted in the through hole in the casing so that the position of the through holes is fixed to form cells; and pulling out the rod member from the cell formed in the applying of pressure so as to be removed.

In the method for manufacturing the honeycomb structure in accordance with the fourth aspect of the present invention, the lamination member is preferably a lamination member mainly including inorganic fibers, manufactured by: forming a sheet-forming slurry into a sheet to manufacture an inorganic fiber aggregated body; drying the inorganic fiber aggregated body; punching the inorganic fiber aggregated body to form through holes with equal intervals over almost entire surface; and heating the inorganic fiber aggregated body at a temperature of at least about 900° C. and at most about 1050° C.

A method for manufacturing a honeycomb structure in accordance with a fifth aspect of the present invention includes: laminating lamination members, each lamination member having the same divided disc shape as a cross section of a cylindrical lamination body perpendicular to a longitudinal direction of the cylindrical lamination body divided by a insertion member, the lamination members being laminated in a manner as to allow a side face plane portion of the lamination members to contact to the insertion member.

In the method for manufacturing the honeycomb structure in accordance with the fifth aspect of the present invention, the lamination member is preferably a lamination member mainly including inorganic fibers, manufactured by: forming a sheet-forming slurry into a sheet to manufacture an inorganic fiber aggregated body; drying the inorganic fiber aggregated body; punching the inorganic fiber aggregated body to form through holes with equal intervals over almost entire surface; and heating the inorganic fiber aggregated body at a temperature of at least about 900° C. and at most about 1050° C.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1A is a perspective view that schematically shows a specific example of a lamination-type honeycomb structure which is formed by laminating disc-shaped lamination members including inorganic fiber aggregated body with through holes, and FIG. 1B is a cross-sectional view taken along the line A-A of FIG. 1A;

FIG. 2A is a perspective view that shows lamination members that form a honeycomb structure, and FIG. 2B is a perspective view that shows a state in which the lamination members shown in FIG. 2A are laminated to manufacture a honeycomb structure;

FIG. 3A is a perspective view that schematically shows one example of the honeycomb structure in accordance with one embodiment of the present invention configured by lamination members, each having an almost disc shape with a chord portion for positioning, and FIG. 3B is a cross-sectional view taken along the line A-A of FIG. 3A;

FIG. 4A is a perspective view that schematically shows lamination members that form the honeycomb structure in accordance with one embodiment of the present invention, and FIG. 4B is a perspective view that shows a state in which the lamination members shown in FIG. 4A are laminated in a casing in accordance with one embodiment of the present invention so that a honeycomb structure is manufactured;

FIG. 5A is a perspective view that schematically shows one example of a honeycomb structure in accordance with one embodiment of the present invention, formed by lamination members each having an almost disc shape with a protruding portion for positioning, and FIG. 5B is a cross-sectional view taken along the line A-A of FIG. 5A;

FIG. 6A is a perspective view that schematically shows lamination members that form the honeycomb structure in accordance with one embodiment of the present invention, and FIG. 6B is a perspective view that shows a state in which the lamination members shown in FIG. 6A are laminated in the casing in accordance with one embodiment of the present invention so that a honeycomb structure is manufactured;

FIG. 7A is a perspective view that schematically shows one example of a honeycomb structure in accordance with one embodiment of the present invention, formed by lamination members each having an almost disc shape with a cut-out portion for positioning, and FIG. 7B is a cross-sectional view taken along the line A-A of FIG. 7A;

FIG. 8A is a perspective view that schematically shows lamination members that form the honeycomb structure in accordance with one embodiment of the present invention, and FIG. 8B is a perspective view that shows a state in which the lamination members shown in FIG. 8A are laminated in the casing in accordance with one embodiment of the present invention so that a honeycomb structure is manufactured;

FIG. 9A is a perspective view that schematically shows one example of a honeycomb structure in accordance with one embodiment of the present invention, formed by lamination members each having an almost disc shape with a cut-out portion for positioning and a cut-out filling member, and FIG. 9B is a cross-sectional view taken along the line A-A of FIG. 9A;

FIG. 10A is a perspective view that schematically shows a lamination member and a cut-out filling member that form the honeycomb structure in accordance with one embodiment of the present invention, and FIG. 10B is a perspective view that shows a state in which the lamination members shown in FIG. 10A are laminated in accordance with the cut-out filling member placed in the casing so that a honeycomb structure is manufactured;

FIG. 11A is a perspective view that schematically shows one example of a honeycomb structure in accordance with one embodiment of the present invention, in which a rod member for positioning is inserted to one portion of the cells, and FIG. 11B is a cross-sectional view taken along the line A-A of FIG. 11A;

FIG. 12A is a perspective view that schematically shows a lamination member that forms the honeycomb structure in accordance with one embodiment of the present invention and a rod member, and FIG. 12B is a perspective view that shows a state in which the lamination members are laminated while the rod member secured to a casing is simultaneously inserted through the through holes of the lamination members shown in FIG. 12A, so that a honeycomb structure is manufactured;

FIG. 13A is a perspective view that schematically shows lamination members and a rod member to be used for a method for manufacturing a honeycomb structure in accordance with one embodiment of the present invention, and FIG. 13B is a perspective view that shows a state in which the honeycomb structure is manufactured by laminating the lamination members while simultaneously inserting the rod member that penetrates a hole of a pressing member into through holes of the lamination members shown in FIG. 13A;

FIG. 14A is a perspective view that schematically shows one example of a honeycomb structure in accordance with one embodiment of the present invention that has the insertion member and the lamination members, each having a divided disc shape formed by dividing a round shape into two portions by the use of the insertion member, and FIG. 14B is a cross-sectional view taken along the line A-A of FIG. 14A;

FIG. 15A is a perspective view that schematically shows the insertion member and the lamination members each having the divided disc shape formed by dividing a round shape into two portions by the insertion member, both of which form the honeycomb structure in accordance with one embodiment of the present invention, and FIG. 15B is a perspective view that shows a state in which the insertion member and the lamination members, shown in FIG. 15A, are laminated in the casing so that a honeycomb structure is manufactured;

FIG. 16 is a perspective view that schematically shows one example of a honeycomb structure in accordance with one embodiment of the present invention that has an insertion member and lamination members each having a divided disc shape formed by dividing a round shape into four portions by the use of the insertion member;

FIG. 17A is a perspective view that schematically shows the insertion member and lamination members, each having a divided disc shape formed by dividing a round shape into four portions by the insertion member, which form a honeycomb structure in accordance with one embodiment of the present invention, and FIG. 17B is a perspective view that shows a state in which the insertion member and lamination members, shown in FIG. 17A, are laminated in a casing so that a honeycomb structure is manufactured;

FIG. 18 is a cross-sectional view that schematically shows one example of an exhaust-gas purifying apparatus for a vehicle in which the honeycomb structure in accordance with one embodiment of the present invention, or the honeycomb structure manufactured by the method for manufacturing the honeycomb structure in accordance with one embodiment of the present invention is installed; and

FIG. 19 is an explanatory drawing that shows a pressure loss measuring apparatus.

### DESCRIPTION OF THE EMBODIMENTS

The following description will discuss the embodiments of a honeycomb structure, a method for manufacturing the honeycomb structure, and a casing in accordance with the present invention.

The honeycomb structure in accordance with the embodiments of the first aspect of the present invention includes the pillar-shaped honeycomb structure having the plurality of cells formed by laminating the plurality of lamination members with the plurality of through holes, the plurality of through holes forming the plurality of cells, wherein the lamination member has the almost disc shape, and the plane portion, the protruding portion, or the cut-out portion is formed on the peripheral side face of the lamination member, or the rod member is inserted in at least one cell of the plurality of cells, the rod member penetrating from one of the ends to the other end of the cell.

The casing in accordance with the embodiments of the third aspect of the present invention is the casing for an exhaust-gas purifying apparatus used for covering the honeycomb structure, wherein the plane portion, the groove portion, or the protruding portion is formed at the region where the lamination members are laminated.

The method for manufacturing the honeycomb structure in accordance with the embodiments of the fourth aspect of the present invention includes: laminating the plurality of lamination members so that the plane portion formed on the peripheral side face of the lamination members is mounted on the plane portion formed on the casing; laminating the plurality of lamination members so that the protruding portion formed in the peripheral side face of the lamination members is fitted into the groove portion formed in the casing; laminating the plurality of lamination members so that the cut-out portion formed in the peripheral side face of the lamination members is fitted to the protruding portion formed in the casing; laminating the plurality of lamination members in a manner so as to allow the cut-out filling member to be inserted to fit into the cut-out portions formed in the peripheral side face of the lamination members; or adjusting the position of through holes by inserting the rod member into at least one of the through holes before or after laminating lamination members.

In the embodiments of the first, third, and fourth aspects of the present invention, since each of the lamination members forming the honeycomb structure has the almost disc shape with the plane portion, the protruding portion, or the cut-out portion for positioning formed on the peripheral side face of the lamination member, the position of the through holes in the respective lamination members tends to be adjusted by fitting the plane portion, the protruding portion, or the cut-out portion formed on the peripheral side face of each of the lamination members to the plane portion, the groove portion, or the protruding portion for positioning formed in the casing.

Moreover, the position of the through holes in the respective lamination members tends to be adjusted by inserting the rod member in at least one cell of the plurality of cells formed by laminating the plurality of lamination members, the rod member penetrating from one of the ends to the other end of the cell.

For this reason, an offset tends not to be caused in the positional relationship among the through holes in the laminated lamination members, and thus it may become easier to surely manufacture a honeycomb structure having a low pressure loss and no clogging of the cells.

Moreover, since the position of the through holes is easily adjusted, it may become easier to manufacture a honeycomb structure with high working efficiency.

The honeycomb structure in accordance with the embodiments of the second aspect of the present invention includes the honeycomb structure including: the cylindrical lamination body formed by laminating the plurality of lamination members each having the plurality of through holes; and the insertion member placed in parallel with the longitudinal direction of the cylindrical lamination body so as to divide the cylindrical lamination body, wherein the lamination member has the same divided disc shape as the cross section perpendicular to the longitudinal direction of the cylindrical lamination body that is divided by the insertion member, the side face plane portion of the laminated lamination members is placed so as to contact to the insertion member, and the plurality of through holes are connected to one another to form the plurality of cells.

The method for manufacturing the honeycomb structure in accordance with the embodiments of the fifth aspect of the present invention includes: laminating the lamination members, each lamination member having the same divided disc shape as the cross section of the cylindrical lamination body perpendicular to the longitudinal direction of the cylindrical lamination body divided by the insertion member, the lamination members being laminated in a manner as to allow the side face plane portion of the lamination members to contact to the insertion member.

In the embodiments of the second and fifth aspects of the present invention, a honeycomb structure, which has a round shape in its cross section perpendicular to the cells, has an insertion member having a shape to divide the round shape, and lamination members each having the same divided disc shape as the cross-sectional shape of the divided round shape; therefore, by laminating the respective lamination members so as not to tend to cause an offset in the positional relationship among the through holes in the respective lamination members, with the side face plane portion of each of the lamination members made in contact with the insertion member, it may become easier to surely manufacture a honeycomb structure having a low pressure loss and no clogging of the cells.

Moreover, since the position of the through holes is easily adjusted, it may become easier to provide a method for manufacturing a honeycomb structure with high working efficiency.

First, the following description will discuss the honeycomb structure in accordance with the embodiments of the first aspect of the present invention, the casing in accordance with the embodiments of the third aspect of the present invention, and the method for manufacturing the honeycomb structure in accordance with the embodiments of the fourth aspect of the present invention.

The honeycomb structure in accordance with the embodiments of the first aspect of the present invention includes the pillar-shaped honeycomb structure having the plurality of cells formed by laminating the plurality of lamination members with the plurality of through holes, the plurality of through holes forming the plurality of cells, wherein the lamination member has the almost disc shape, and the plane portion, the protruding portion, or the cut-out portion is formed on the peripheral side face of the lamination member, or the rod member is inserted in at least one cell of the plurality of cells, the rod member penetrating from one of the ends to the other end of the cell.

Hereinbelow, the following description will successively discuss: a honeycomb structure having a plane portion on a peripheral side face of a lamination member; a honeycomb structure having a protruding portion on a peripheral side face of a lamination member; a honeycomb structure having a cut-out portion on a peripheral side face of a lamination member; a honeycomb structure having a cut-out portion with a cut-out filling member being inserted to fit into the cut-out portion; and a honeycomb structure with a rod member being inserted in a cell.

Moreover, the description will also discuss the casing in accordance with the third aspect of the present invention and the method for manufacturing the honeycomb structure in accordance with the fourth aspect of the present invention.

First, the following description will discuss the honeycomb structure having the plane portion on the peripheral side face of the lamination member among the honeycomb structures in accordance with the embodiments of the present invention. The description will also discuss the casing in accordance with the third aspect of the present invention used for manufacturing the honeycomb structure and the method for manufacturing the honeycomb structure in accordance with the fourth aspect of the present invention. Here, since the characteristics, materials and the like of the honeycomb structure described below are in common with all the honeycomb structures, a detailed description thereof will be described here, and only a necessary item will be described hereafter.

That is, the honeycomb structure in accordance with the embodiments of the first aspect of the present invention is a pillar-shaped honeycomb structure having a plurality of cells formed by laminating a plurality of lamination members each having a plurality of through holes, and is characterized in that the most part of the peripheral trimming loop (outer circumference) of its cross section perpendicular to the cells is formed of an arc centered on one point in its cross section, and the rest of the peripheral trimming loop is formed of a line segment having a distance from the center that is different from the radius of the arc.

Here, although there is no particular limitation to the range of the most part of the peripheral trimming loop, about 80% or more of the length of the peripheral trimming loop is given as one standard.

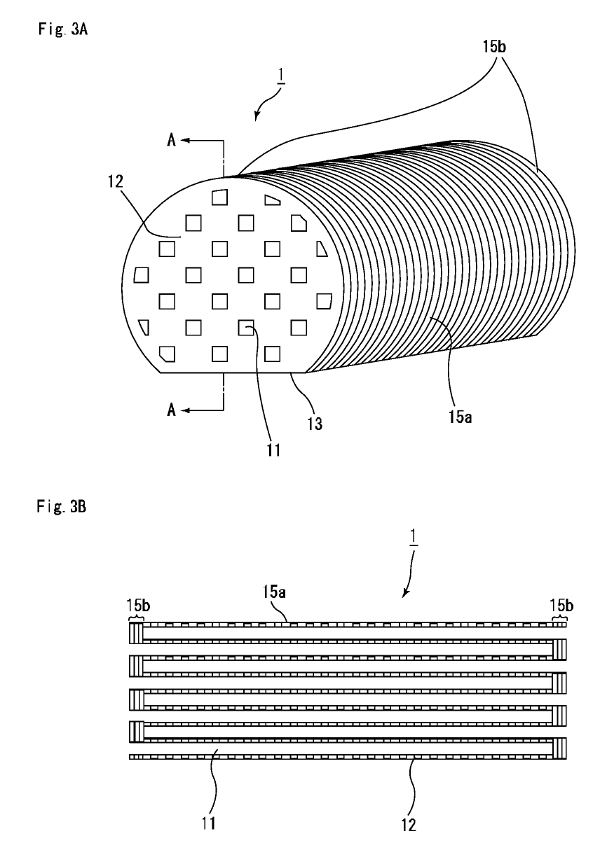

The shape of the line segment having a distance that is different from the radius of the arc is not particularly limited, and the shape may include a plane as shown by a chord portion of the honeycomb structure in accordance with the embodiments of the first aspect of the present invention which will be described later (see FIG. 3A), or a curved face. Moreover, the shape of the curved face is also not particularly limited.

Here, in the present specification, a plane portion, which is formed on the peripheral side face of each of the lamination members having an almost (i.e. substantially) disc shape (including lamination members for an end portion), which form a honeycomb structure in accordance with the embodiments of the first aspect of the present invention, is referred to as the chord portion.

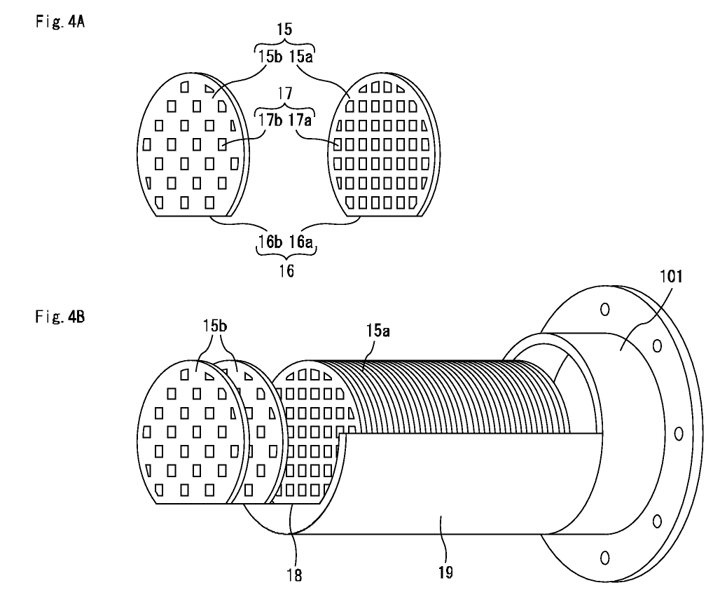

FIG. 3A is a perspective view that schematically shows one example of the honeycomb structure in accordance with one embodiment of the present invention configured by lamination members, each having an almost disc shape with a chord portion for positioning, and FIG. 3B is a cross-sectional view taken along the line A-A of FIG. 3A. FIG. 4A is a perspective view that schematically shows lamination members that form the honeycomb structure in accordance with one embodiment of the present invention, and FIG. 4B is a perspective view that shows a state in which the lamination members shown in FIG. 4A are laminated in a casing in accordance with one embodiment of the present invention so that a honeycomb structure is manufactured.

The honeycomb structure 1 in accordance with the embodiments of the first aspect of the present invention has an almost cylindrical shape, and has lamination members 15a, each having a number of through holes 17a with a wall portion 12 (cell wall) therebetween, which are laminated so as to allow the through holes 17a to be superposed on one another. The respective through holes 17a, formed in the lamination members, are communicated with each other from one of the ends of the honeycomb structure 1 to the other end to form cells 11, and either one of the ends of the cell formed by the communication of the through holes (hereinafter, referred to as “communicating cell”) is sealed by a lamination member 15b for an end portion. Here, the lamination member for an end portion will be described later in detail.

As shown in FIG. 3B, either one of the ends of the communicating cell 11 corresponding to the gas-inlet side or the gas-outlet side is sealed so that exhaust gases, introduced into one of the cells 11, are allowed to flow out from another cell 11, after always having passed through the cell wall 12 separating the cells 11. In other words, the cell wall 12 is allowed to function as a filter.

Each of the lamination members 15a forming the honeycomb structure 1 has an almost disc shape, and a chord portion 16a for positioning, which has a planar shape, is placed on a side face of each of the lamination members 15a. Here, a chord portion 13 of the honeycomb structure 1 is formed by laminating the lamination members 15a while adjusting the position of these chord portions 16a.

These chord portions 16a are portions provided for adjusting the position of the through holes 17a formed in the respective lamination members, and, upon manufacturing the lamination members 15a, when the respective lamination members are formed so as to have the same positional relationship between the through holes 17a and the chord portions 16a formed in each of the lamination members, by adjusting the position of the chord portions 16a of the respective lamination members 15a upon laminating the lamination members, the position of all the through holes 17a tends to be adjusted to form the cells 11.

A lamination member 15b for an end portion having through holes 17b formed in a grid pattern is preferably laminated on both sides of the laminated lamination members 15a.

By laminating the lamination member 15b for an end portion, it is possible to seal either one of the ends of the communicating cells formed by laminating the lamination members, without the necessity of sealing the through holes of the lamination member 15a located at the end with a plug and the like, before laminating the lamination member 15b for an end portion.

In this case, by also forming a chord portion 16b having the same shape as that of the lamination member 15a at a predetermined position of the lamination member 15b for an end portion, the position of each of the through holes 17a of the lamination members 15a and the position of each of the through holes 17b of the lamination member 15b for an end portion tend to be fitted to each other without causing any positional deviation.

In this manner, by using the lamination member for an end portion having the chord portion that has the same shape as that of the lamination member, it may become easier to surely manufacture a honeycomb structure having an almost cylindrical shape in which a number of cells 11, with either one of the ends of each cell sealed, are longitudinally placed in parallel with one another with a cell wall 12 therebetween, which has a low pressure loss and has no clogging of the cells.

Next, the following description will discuss the structure, characteristics, materials and the like of the honeycomb structure in accordance with the embodiments of the first aspect of the present invention in detail.

The honeycomb structure in accordance with the embodiments of the first aspect of the present invention is preferably configured by at least one of lamination members mainly including inorganic fibers (hereinafter, referred to also as inorganic fiber lamination members) and lamination members mainly including metal (hereinafter, referred to also as metal lamination members). By using these lamination members, it may become easier to manufacture a honeycomb structure that is superior in strength even when it is allowed to have a superior heat resistant property or a high porosity.

Upon laminating the lamination members, only the inorganic fiber lamination members may be laminated, or only the metal lamination members may be laminated. Moreover, the inorganic fiber lamination members and the metal lamination members may be laminated in combination. Upon laminating the above-mentioned two kinds of lamination members in combination, the order of laminations is not particularly limited.

With respect to the thickness of the lamination member, it is preferably at least about 0.1 mm and at most about 20.0 mm; however, depending on the material or the like of the lamination members, lamination members having a thickness of more than about 20.0 mm may be laminated to manufacture a honeycomb structure.

With respect to the apparent density of the honeycomb structure, a preferable lower limit value is about 0.04 g/cm³ and a preferable upper limit value is about 0.4 g/cm³.

The apparent density of about 0.04 g/cm³ or more tends not to result in insufficient strength and consequently not to make the resulting product to be destroyed easily. Here, the apparent density of about 0.4 g/cm³ or less is preferable, since this level is suitable for continuously burning PMs. In the present specification, the apparent density refers to a value obtained by dividing the mass (g) of a sample by the apparent volume (cm³) of the sample, and the apparent volume refers to a volume including pores and apertures (cells) of the sample.

Moreover, the porosity of the honeycomb structure is preferably at least about 70% and at most about 95%.

When the porosity is about 70% or more, it may become easier to raise the inner temperature of the filter to a temperature required for burning PMs upon regenerating a filter, and also, since it may become easier for PMs to enter the inside of each pore, the continuous regenerating capability of the honeycomb structure tends not to be lowered. In contrast, when the porosity is about 95% or less, the occupying rate of pores tends not to become too high, and therefore it may become easier to properly maintain the strength of the entire honeycomb structure.

Furthermore, when the porosity on the gas-flow-out side is made greater than the porosity on the gas-flow-in side within the respective range of the porosities, it may become easier to restrain occurrence of a temperature difference in the lamination direction of the honeycomb structure upon burning deposited PMs, and consequently to prevent damages to the honeycomb structure; therefore, this arrangement is effective.

Moreover, in the above-mentioned honeycomb structure, the distance between adjacent cells (that is, the thickness of a cell wall) is preferably about 0.2 mm or more. When the distance is about 0.2 mm or more, the strength of the honeycomb structure tends not to be deteriorated.

Here, with respect to the distance between adjacent cells (the thickness of the cell wall), a preferable upper limit is about 5.0 mm. When the thickness of the cell wall is about 5.0 mm or less, at least one of the aperture ratio and the filtration area of each cell tend not to become smaller, and therefore pressure loss tends not to increase. Moreover, it may become easier to prevent ashes generated upon burning of PMs from entering the pores deeply, and from not drawing the ashes. Supposing that an area within which deep-layer filtering of PMs can be carried out is set as an effective area of a wall for soot capturing, the rate of the effective area relative to the honeycomb structure tends not to be lowered.

The average pore diameter of the honeycomb structure is not particularly limited, and the lower limit is preferably about 1 μm, and the upper limit is preferably about 100 μm. When the average pore diameter is about 1 μm or more, PMs tend to be filtered at the deep layers inside the cell walls, with the result that the PMs tend to be made in contact with the catalyst supported on the inside of the cell wall. On the other hand, when the average pore diameter is about 100 μm or less, PMs tend not to pass through the pores and thus the PMs tend to be captured sufficiently, therefore the honeycomb structure tends to sufficiently function as a filter.

Here, the above-mentioned porosity and pore diameter can be measured through known methods, such as a measuring method using a mercury porosimeter, a weighing method, Archimedes method and a measuring method using a scanning electron microscope (SEM).

In the above-mentioned honeycomb structure, the cell density on a plane face in parallel with the lamination face of the lamination members is not particularly limited, and a preferable lower limit is about 0.16 pcs/cm² (about 1.0 pcs/in²), and a preferable upper limit is about 93.0 pcs/cm² (about 600.0 pcs/in²). A more preferable lower limit is about 0.62 pcs/cm² (about 4.0 pcs/in²), and a more preferable upper limit is about 77.5 pcs/cm² (about 500.0 pcs/in²).

Moreover, with respect to the size of a cell on a plane face in parallel with the lamination face of the lamination members of the honeycomb structure, a preferable lower limit is about 0.8 mm×about 0.8 mm, and a preferable upper limit is about 16.0 mm×about 16.0 mm, although not particularly limited thereto.

With respect to the aperture ratio of the honeycomb structure, a lower limit is about 30%, and an upper limit is about 60%. In the case where the aperture ratio is about 30% or more, a high pressure loss tends not to be caused when exhaust gases flows in and out of the honeycomb structure, and in the case where the aperture ratio is about 60% or less, the strength of the honeycomb structure tends not to be deteriorated.

Examples of the material for the inorganic fibers forming the inorganic fiber lamination member include: oxide ceramics such as silica-alumina, mullite, alumina, silica, titania and zirconia; nitride ceramics such as silicon nitride and boron nitride; carbide ceramics such as silicon carbide; basalt, and the like. Each of these materials may be used alone, or two or more of them may be used in combination.

Desirably, the lower limit value of the fiber length of the inorganic fibers is about 0.1 mm, and the upper limit value thereof is about 100.0 mm; more desirably, the lower limit value thereof is about 0.5 mm, and the upper limit value thereof is about 50.0 mm. Desirably, the lower limit value of the fiber diameter of the inorganic fibers is about 0.3 μm, and the upper limit value thereof is about 30.0 μm; and more desirably, the lower limit value thereof is about 0.5 μm, and the upper limit value thereof is about 15.0 μm.

In addition to the inorganic fibers, the above-mentioned inorganic fiber lamination member may contain a binder that unites these inorganic fibers to each other so as to maintain a predetermined shape.

Examples of the binder include: inorganic glass such as silicate glass, silicate alkali glass and borosilicate glass, alumina sol, silica sol, titania sol, and the like.

The inorganic fiber lamination member may contain a slight amount of inorganic particles and metal particles.

Moreover, in the inorganic fiber lamination member, the inorganic fibers may be firmly fixed with one another by an inorganic substance containing silica, and the like. In this case, preferably, the inorganic fibers are mutually fixed not over a certain range of length along the length direction of the inorganic fibers (or over the entire surface of inorganic fiber), but at crossing points of the inorganic fibers or neighborhood of these points. With this arrangement, it may become easier to obtain inorganic fiber lamination members having superior strength and flexibility.

The fixed state at the crossing points or neighborhood of these points refers to a state in which the inorganic fibers are mutually fixed through an inorganic substance that is locally placed (present) at the mutual crossing points of the inorganic fibers (where the inorganic fibers may be mutually made in contact with each other, or may not be made in contact with each other), a state in which the inorganic fibers are mutually fixed through an inorganic substance that is locally placed (present) near the mutual crossing points of the inorganic fibers, or a state in which the inorganic fibers are mutually fixed through an inorganic substance that is locally placed (present) at the entire area of the mutual crossing points of the inorganic fibers and neighborhood thereof.

With respect to the inorganic substance containing silica, examples thereof include inorganic glass materials, such as silicate glass, silicate alkali glass and borosilicate glass.

Examples of the material for the metal lamination members include chrome-based stainless steel, chrome-nickel-based stainless steel and the like, although not particularly limited thereto.

Moreover, each of the above-mentioned metal lamination members is preferably a structured body which is formed of the three-dimensionally entangled metal fibers including the above-mentioned metals, a structured body including the above-mentioned metal, in which penetrating pores are formed by a pore-forming material, or a structured body that is formed by sintering metal powder including the above-mentioned metal so as to allow pores to remain therein.

Onto each of the two ends of at least one of the above-mentioned laminated inorganic lamination members and the above-mentioned laminated metal lamination members, a lamination member for an end portion having through holes formed in a grid pattern is preferably laminated.

By laminating the lamination member for an end portion, either one of the ends of communicating cells formed by laminating the lamination members can be sealed, without the necessity of sealing the through holes of the lamination members that have been preliminarily placed on the end portion prior to laminating the lamination member for an end portion by using a plug and the like.

The above-mentioned lamination member for an end portion preferably includes the same material as that of the inorganic fiber lamination members or the metal lamination members, or a dense material, and has through holes which are formed preferably in a grid pattern.

In the present specification, the dense material refers to a material having a porosity smaller than that of the material forming the lamination members, and specific examples thereof include metal, ceramics and the like.

When the dense material is used, it becomes possible to make the lamination member for an end portion thinner.

With respect to the lamination member for an end portion, a material including a solid metal (dense metal) is preferably used.

With respect to the combination between the lamination members and the lamination member for an end portion, the following combinations are listed: (1) a combination of an inorganic fiber lamination member as the lamination member, with a lamination member including an inorganic fiber lamination member, an metal lamination member or a dense material, in which through holes are formed in a grid pattern, as the lamination member for an end portion; (2) a combination of a metal lamination member as the lamination member, with a lamination member including an inorganic fiber lamination member, an metal lamination member or a dense material, in which through holes are formed in a grid pattern, as the lamination member for an end portion; and (3) a combination of an inorganic fiber lamination member and a metal lamination member used in combination as the lamination member, with a lamination member including an inorganic fiber lamination member, an metal lamination member or a dense material, in which through holes are formed in a grid pattern, as the lamination member for an end portion.

Among the above-mentioned combination, the combination (1) is preferably used. This combination needs fewer kinds of lamination members required for forming the honeycomb structure, and makes it possible to easily manufacture the lamination members.

Moreover, a lamination member for an end portion made from a dense material is preferably used as the lamination member for an end portion because this structure tends to prevent soot from leaking through the sealed portion.

Moreover, in a case where only the metal lamination members are used as the lamination members and in a case where the lamination member for an end portion including a metal lamination member or solid metal, having through holes formed in a grid pattern, is further layered on the both ends of laminated inorganic fiber lamination members and metal lamination members, it may become easier to prevent wind erosion or erosion, even after a long time use.

Moreover, in a case where each of the above-mentioned combinations is used, even at high temperatures (in use), it may become easier to prevent a gap between the metal casing and the honeycomb structure from occurring due to a difference in thermal expansions, as well as a gap between the respective lamination members from occurring. As a result, it becomes possible to prevent PMs in exhaust gases from leaking to cause a reduction in the PM collecting efficiency.

Here, the shape of the above-mentioned cell on the planar view is not particularly limited to a square shape, and any desired shape, such as a triangular shape, a hexagonal shape, an octagonal shape, a dodecagonal shape, a round shape, an elliptical shape and a star shape, may be used.

A catalyst is preferably supported on the lamination members that form the honeycomb structure.

The catalyst may be supported on all the lamination members, or may be supported on one portion of the lamination members. With respect to the single lamination member, a catalyst may be supported on the entire surface of the lamination member, or on one portion thereof.

Examples of the catalyst include a noble metal such as platinum, palladium and rhodium, an alkali metal, an alkali earth metal and an oxide, as well as a combination of these.

Examples of the oxide include metal oxides such as CeO₂, ZrO₂, FeO₂, Fe2O3, CuO, CuO₂, Mn₂O₃ and MnO, and composite oxides represented by the composition formula AnB1-nCO₃ (in the formula, A is La, Nd, Sm, Eu, Gd or Y; B is an alkali metal or alkali-earth metal; and C is Mn, Co, Fe or Ni). By supporting the oxide catalyst on the lamination members, it may become easier to lower the temperature for burning PMs.

Each of these catalysts may be used alone, or two or more kinds of these may be used in combination.

The amount of the supported catalyst with respect to the apparent volume of the honeycomb structure is preferably at least about 10 g/l (liter) and at most about 200 g/l.

When the amount of the supported catalyst is about 10 g/l or more, portions of the honeycomb structure on which no catalyst is supported tends not to exist, and the possibility of PMs coming into contact with the catalyst tends not to reduce, thus the temperature for burning PMs tends to sufficiently be reduced. On the other hand, when the amount is more than 200 g/l, the catalyst is excessively supplied, while the possibility of PMs coming into contact with the catalysts tends not to be improved so much, thus 200 g/l or less is preferable.

The honeycomb structure is preferably designed to have a heat resistant temperature of about 1000° C. or more.

When the heat resistant temperature is about 1000° C. or more, a breakage such as melting down tends not to occur in the honeycomb structure especially upon burning of a large amount of PMs (for example, about 3 g/l or more) for a regenerating process.

In particular, in a case where an oxide catalyst is supported on the honeycomb structure, since the temperature of the honeycomb structure tends to easily increase, the heat resistant temperature is preferably set within the above-mentioned range.

Here, in order to avoid a decrease in fuel efficiency of an internal combustion engine, the regenerating process of the honeycomb structure is preferably carried out with at least about 2 g/l and at most about 3 g/l of PMs deposited in the honeycomb structure.

The above-mentioned lamination members may be mutually bonded by using an inorganic adhesive or the like, or may be simply laminated mechanically, and it is preferable for them to be simply laminated mechanically. With the simply laminated structure, it may become easier to prevent increase in pressure loss caused by interference of the flow of exhaust gases at the joined portions (or bonded portions) to which an adhesive or the like has been applied.

In order to simply laminate the lamination members to form a lamination body, they may be laminated inside a metal casing, which will be described later, and a pressure is applied thereto.

The above-mentioned honeycomb structure is normally placed inside a metal casing having a cylindrical shape (can-type).

Examples of the material for the metal casing include, for example, metals such as stainless steel (SUS), aluminum and iron.

The shape of the metal casing may be a cylindrical body of an integral type, or a cylindrical body that can be divided into two or more portions (for example, a clam-shell-type metal casing and the like).

A casing 101 in accordance with the embodiments of the third aspect of the present invention, which is used for installing the honeycomb structure in accordance with the embodiments of the first aspect of the present invention, is preferably formed into an almost cylindrical shape having a plane portion 18 in its cross-sectional shape, and the shape of the plane portion 18 should be determined by the shape of a chord portion 16a of lamination members 15a to be laminated.

FIG. 4B shows a cylindrical portion 19 that forms the casing 101, with the upper portion thereof omitted, and the actual casing has a cylindrical portion having a shape covering the entire periphery of the peripheral portion of the lamination members to be laminated. With respect to the method for adjusting the position of the through holes of the respective lamination members by using the casing, the description thereof will be given in the section of the manufacturing method later.

The following description will discuss a method for manufacturing the honeycomb structure in accordance with the embodiments of the fourth aspect of the present invention.

(1) Method for Manufacturing an Inorganic Fiber Lamination Member, and a Lamination Member for an End Portion including Inorganic Fibers.

First, sheet-forming slurry is prepared. Specifically, for example, inorganic fibers and an inorganic substance such as inorganic glass are sufficiently mixed, and an appropriate amount of water, an organic binder, an inorganic binder and the like are further added thereto, if necessary, and by sufficiently stirring the mixture, the sheet-forming slurry is prepared.

Next, by using the sheet-forming slurry, a lamination member mainly including inorganic fibers is sheet-formed.

Specifically, first, the sheet-forming slurry is formed into a sheet to obtain an inorganic fiber aggregated body with an almost disc shape having a chord portion for positioning. The resulting product is dried at a temperature of at least about 100° C. and at most about 200° C., and further a punching is carried out on the inorganic fiber aggregated body so that through holes are formed with equal intervals over almost the entire surface. Thereafter, a heating treatment is carried out on the resulting product at a temperature of at least about 900° C. and at most about 1050° C., so that an inorganic fiber lamination member as shown in FIG. 4A with a predetermined thickness, having through holes formed therein with high density, and having a chord portion for positioning is manufactured.

Moreover, in a case where a lamination member for an end portion is manufactured by using inorganic fibers, the sheet-forming slurry is formed into a sheet by using a mesh to obtain an inorganic fiber aggregated body having an almost disc shape with a chord portion for positioning. The resulting product is dried at a temperature of at least about 100° C. and at most about 200° C., and a punching is further carried out on the inorganic fiber aggregated body so that through holes having a grid pattern are formed therein. Thereafter, a heating treatment is carried out on the resulting product at a temperature of at least about 900° C. and at most about 1050° C., so that a lamination member for an end portion having predetermined through holes formed therein with low density is manufactured.

With respect to the method for adjusting the porosity of the inorganic fiber lamination member, for example, a method in which, in the sheet-forming of the inorganic fibers, a thickness of the resulting sheet product is adjusted by the number of times of the sheet-forming, a method in which the heating treatment is carried out while the sheet-formed inorganic fiber lamination member is being compressed, and the like may be used.

By using the method as described above, it is possible to manufacture an inorganic fiber lamination member 15a and a lamination member 15b for an end portion, which have inorganic fibers that are mutually fixed by an inorganic substance, such as inorganic glass, at crossing portions of the inorganic fibers or at neighborhood portions of the crossing portions.

Moreover, an oxidizing and a quenching treatment may be further carried out on the inorganic fiber lamination member and the lamination member for an end portion that have been heat-treated.

After the inorganic fiber lamination member and the lamination member for an end portion have been manufactured, a catalyst is supported thereon, if necessary. In a case where a catalyst is supported thereon, the catalyst may be preliminarily supported on inorganic fibers, such as alumina fibers, that are constituent elements. When the catalyst is supported on inorganic fibers prior to the sheet-forming, the catalyst is allowed to adhere in a more evenly dispersed state.

With regard to the method for supporting a catalyst on the inorganic fibers serving as the constituent elements or on the inorganic fiber lamination members, for example, a method in which, after inorganic fibers or inorganic fiber lamination members have been immersed in slurry containing a catalyst, these are taken out and then heated and dried, and the like are proposed. By repeating the immersing into the slurry and the heating and drying treatments, the amount of the catalyst supported on the inorganic fibers or the inorganic fiber lamination members tend to be adjusted. The catalyst may be supported on the entire portion of the inorganic fibers or inorganic fiber lamination members, or may be supported on one portion thereof. Additionally, the catalyst may be supported after the sheet-forming.

(2) Method for Manufacturing Metal Lamination Members and a Lamination Member for an End Portion including Metal.

First, a porous metal plate, which mainly includes metal, having an almost disc shape of a thickness of at least about 0.1 mm and at most about 20.0 mm with a chord portion for positioning is prepared, and then a laser machining or a punching is carried out on the porous metal plate so that through holes are formed on almost the entire surface with almost equal intervals from each other; thus, as shown in FIG. 4A, a lamination member, in which through holes are formed with high density, is manufactured.

Moreover, when a lamination member for an end portion, which is placed at the end face neighborhood of the honeycomb structure to form a sealed portion of cells, is manufactured, through holes are formed in a grid pattern upon laser-machining so that a lamination member for an end portion in which through holes are formed with low density is manufactured.

By using one to several sheets of the lamination members for an end portion with the through holes formed therein with low density, it is possible to obtain a honeycomb structure capable of functioning as a filter, without the necessity of sealing predetermined cells at the end portion.

Here, the lamination member for an end portion may be prepared not as those including inorganic fibers as mentioned above, but as a plate member including a dense material such as ceramics and metal.

Next, a catalyst is supported on the metal lamination member, if necessary.

Examples of the method for supporting an oxide catalyst include, for example, a method in which a metal lamination member is immersed in a solution containing about 10 g of CZ(nCeO₂.mZrO₂), about 1 l(liter) of ethanol, about 5 g of citric acid and an appropriate amount of pH adjusting agent for about 5 minutes, and a firing is carried out at about 500° C. on the resulting product, and the like.

In this case, by repeating the above-mentioned immersing and the firing, the amount of catalyst to be supported tends to be adjusted.

Here, the above-mentioned catalyst may be supported on one portion of the metal lamination member, or may be supported on the entire metal lamination member.

### (3) Lamination.

As shown in FIG. 4B, a metal casing 101, which has an almost cylindrical shape with a pressing member at its end portion on the gas-inlet side, is used, and the lamination members 15b for an end portion and the lamination members 15a manufactured by (1) and (2) are laminated inside the metal casing 101. Here, the lamination members may be inorganic fiber lamination members, or metal lamination members, or may be a combination of these.

First, on the end portion on the gas-inlet side, one to several sheets of the lamination members 15b for an end portion are laminated so as to be made in contact with the pressing member, with the position of the chord portion 16b of each lamination member 15b for an end portion and the position of the plane portion 18 of the casing 101 adjusted to fit each other, and a predetermined number of the lamination members 15a are laminated thereon, with the position of the chord portions 16a thereof and the position of the plane portion 18 of the casing 101 adjusted to fit each other.

Moreover, the lamination member 15b for an end portion is laminated thereon with the position of its chord portion 16b adjusted to fit with the plane portion 18 of the casing 101. In this case, attention is paid to the orientation of the lamination member 15b for an end portion upon lamination so that either one of the ends of each cell is sealed.

Thereafter, the aggregated body of the lamination members is compressed so as to have a predetermined apparent density, and while the compressed state is being maintained, the pressing member is attached to the end portion on the gas-outlet side, and secured thereon. These processes make it possible to manufacture a honeycomb structure which keeps a predetermined lamination structure.

In the lamination of the method for manufacturing the honeycomb structure in accordance with the embodiments of the fourth aspect of the present invention, by adjusting the positions of the chord portion 16 of each lamination member and the plane portion 18 of the casing to fit each other, the respective lamination members are laminated so as to allow the corresponding through holes 17 to be superposed on one another. Moreover, in a case where a dense material plate-shaped member including metal is used as the lamination member for an end portion, this may be welded so as to serve as the pressing member.

In the method for manufacturing the honeycomb structure in accordance with the embodiments of the fourth aspect of the present invention, since the chord portions 16 are fixed in association with the shape of the plane portion 18, the lamination members 15 tends to be prevented from rotating inside the casing so that an offset tends not to be caused in the positional relationship among the through holes 17; therefore, it may become easier to surely manufacture the honeycomb structure in accordance with the embodiments of the first aspect of the present invention having a low pressure loss and no clogging of the cells.

Moreover, in the method for manufacturing the honeycomb structure in accordance with the embodiments of the fourth aspect of the present invention, since the position among the lamination members is adjusted by simply adjusting the position of the chord portions 16 of the lamination members 15 and the position of the plane portion 18 of the casing 101 to fit each other, the time required for laminating the lamination members tends to be greatly shortened, and thus the honeycomb structure in accordance with the embodiments of the first aspect of the present invention tends to be manufactured with high working efficiency.

Next, the following description will discuss the honeycomb structure having the protruding portion on the peripheral side face of the lamination member among the honeycomb structures in accordance with the embodiments of the present invention. The description will also discuss the casing in accordance with the third aspect of the present invention used for manufacturing the honeycomb structure and the method for manufacturing the honeycomb structure in accordance with the fourth aspect of the present invention.

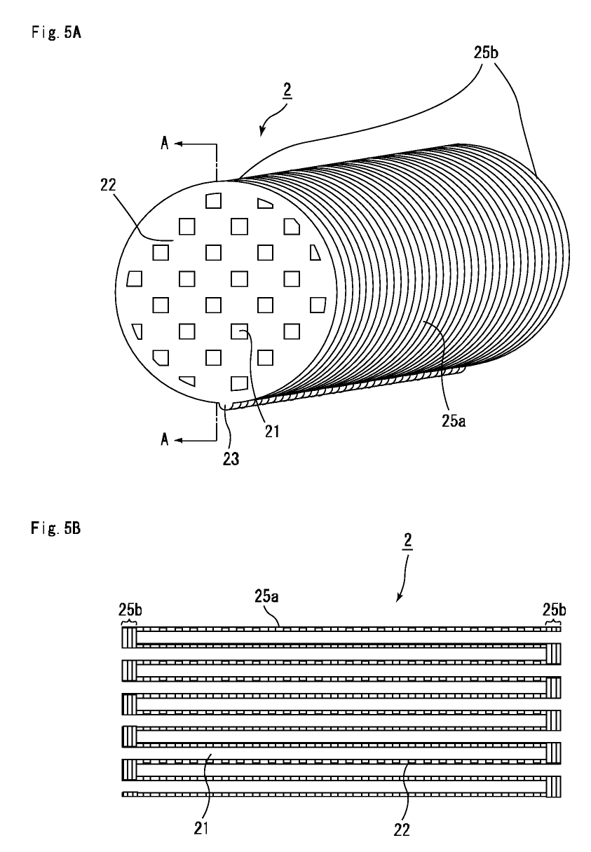

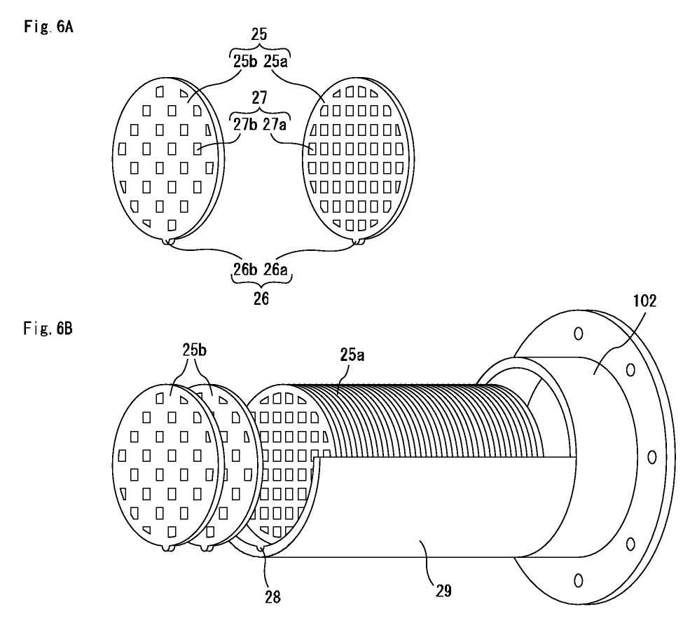

FIG. 5A is a perspective view that schematically shows one example of a honeycomb structure in accordance with one embodiment of the present invention, formed by lamination members each having an almost disc shape with a protruding portion for positioning, and FIG. 5B is a cross-sectional view taken along the line A-A of FIG. 5A. FIG. 6A is a perspective view that schematically shows lamination members that form the honeycomb structure in accordance with one embodiment of the present invention, and FIG. 6B is a perspective view that shows a state in which the lamination members shown in FIG. 6A are laminated in the casing in accordance with one embodiment of the present invention so that a honeycomb structure is manufactured.

In a honeycomb structure 2, lamination members 25a are laminated, cells 21 being formed, and the most portion of the peripheral trimming loop of each of the lamination members (lamination face of the lamination members) is formed by an arc centered on one point within the cross section, and the rest of the peripheral trimming loop is formed by a line segment, whose distance from the center is different from the radius of the arc.

In the honeycomb structure 2 having the protruding portion on the peripheral side face of the lamination member shown in FIG. 5A, a protruding portion 23 is formed on one portion of the peripheral trimming loop as the rest of the portion. Here, either one of the ends of each cell is sealed by the lamination member 25b for an end portion.

This protruding portion 23 is formed by laminating the lamination members 25a, which form the honeycomb structure 2, with the positions of protruding portions 26a formed on the respective lamination members 25a adjusted to fit each other.

The protruding portion 23 is a portion provided for adjusting the position of the through holes 27a formed in each lamination member, and in a case where, upon manufacturing each of the lamination members 25a, the lamination members are formed so as to have the same positional relationship between the through hole 27a and the protruding portions 26a formed in each lamination member, by adjusting the position of the protruding portions 26a of the respective lamination members 25a upon lamination, the position of all the through holes 27a tend to be adjusted so that cells 21 are formed.

Here, the shape of the protruding portion is not particularly limited, and any shape such as an almost semicircular shape, an almost triangular shape and an almost quadrilateral shape, may be used. Moreover, the size of the protruding portion is not particularly limited, and any size may be used as long as, upon insertion of the protruding portion into the groove portion formed in the casing, it prevents the lamination members from rotating, as will be described later.

The casing 102 in accordance with the embodiments of the third aspect of the present invention, which is used for installing the honeycomb structure having the protruding portion on the peripheral side face of the lamination member, is preferably formed into an almost cylindrical shape with a groove portion 28 for positioning prepared in its cross-sectional shape, and preferably, the shape of the grooved portion 28 is almost the same as that of the protruding portion 26a of each of the lamination members 25a to be laminated, and the shape preferably allows the protruding portion 26a to be fitted and inserted thereto.

In the method for manufacturing the honeycomb structure having the protruding portion on the peripheral side face of the lamination member in accordance with the embodiments of the fourth aspect of the present invention, at the lamination, first, on the end portion on the gas-inlet side, one to several sheets of the lamination members 25b for an end portion are laminated so as to be made in contact with the pressing member, with the position of the protruding portion 26b of each lamination member 25b for an end portion and the position of the groove portion 28 of the casing 102 adjusted to fit each other, and a predetermined number of the lamination members 25a are laminated thereon, with the position of the protruding portions 26a thereof and the position of the groove portion 28 of the casing 102 adjusted to fit each other, and moreover, the lamination member 25b for an end portion is laminated thereon with the position of its protruding portion 26b adjusted to fit with the groove portion 28 of the casing 102.

Thereafter, the aggregated body of the lamination members is compressed so as to have a predetermined apparent density, and while the compressed state is being maintained, the pressing member is attached to the end portion on the gas-outlet side, and secured thereon. These processes make it possible to manufacture a honeycomb structure which keeps a predetermined lamination structure.

In the lamination of the method for manufacturing the honeycomb structure in accordance with the embodiments of the fourth aspect of the present invention, by adjusting the positions of the protruding portion 26 of each lamination member and the groove portion 28 of the casing to fit each other, the respective lamination members are laminated so as to allow the corresponding through holes 27 to be superposed on one another.

In the method for manufacturing the honeycomb structure in accordance with the embodiments of the fourth aspect of the present invention, since the protruding portions 26a are fixed in association with the shape of the groove portion 28, the lamination members 25a tend to be prevented from rotating inside the casing so that an offset tends not to be caused in the positional relationship among the through holes 27a; therefore, it may become easier to surely manufacture the honeycomb structure in accordance with the embodiments of the first aspect of the present invention having a low pressure loss and no clogging of the cells.

Moreover, in the method for manufacturing the honeycomb structure in accordance with the embodiments of the fourth aspect of the present invention, since the position among the lamination members is adjusted by simply adjusting the position of the protruding portions 26a of the lamination members 25a and the position of the groove portion 28 of the casing 102 to fit each other, the time required for laminating the lamination members tends to be greatly shortened, and thus the honeycomb structure in accordance with the embodiments of the first aspect of the present invention tends to be manufactured with high working efficiency.

The structure, characteristics, materials and the like of the honeycomb structure having the protruding portion on the peripheral side face of the lamination member as well as the casing and the method for manufacturing the honeycomb structure are the same as those of the honeycomb structure having the plane portion on the peripheral side face of the lamination member and the method for manufacturing the honeycomb structure, except that the protruding portion is formed in place of the chord portion formed in the lamination members and the lamination member for an end portion, that the groove portion is formed in place of the plane portion formed on the casing, and that the lamination is different; therefore, the description thereof will be omitted.

Next, the following description will discuss the honeycomb structure having the cut-out portion on the peripheral side face of the lamination member among the honeycomb structures in accordance with the embodiments of the first aspect of the present invention. The description will also discuss the casing in accordance with the third aspect of the present invention used for manufacturing the honeycomb structure and the method for manufacturing the honeycomb structure in accordance with the fourth aspect of the present invention.

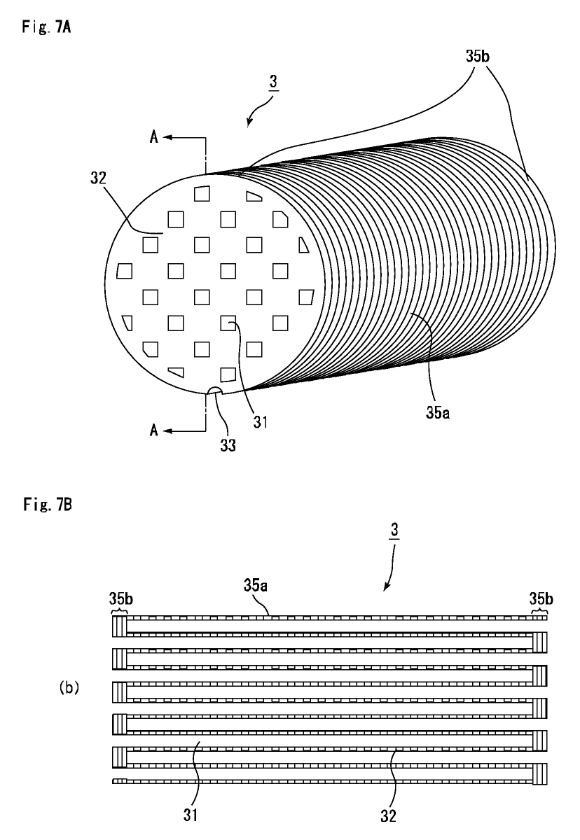

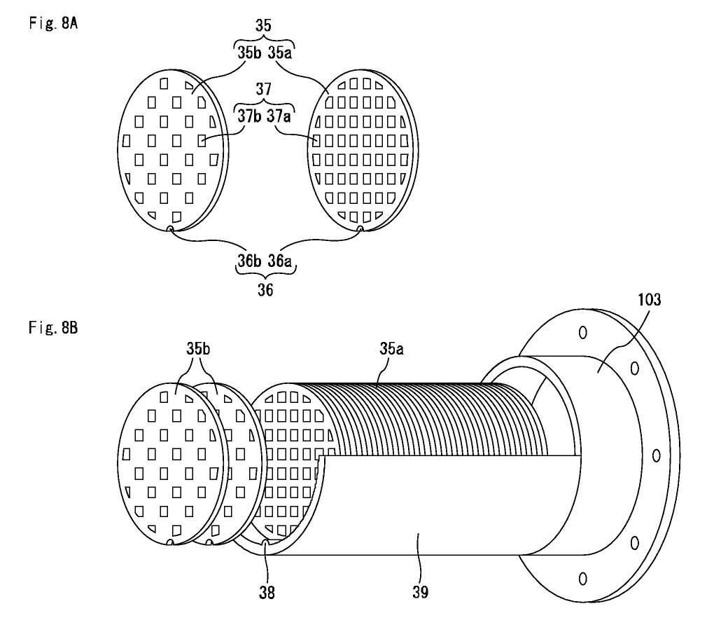

FIG. 7A is a perspective view that schematically shows one example of a honeycomb structure in accordance with one embodiment of the present invention, formed by lamination members each having an almost disc shape with a cut-out portion for positioning, and FIG. 7B is a cross-sectional view taken along the line A-A of FIG. 7A. FIG. 8A is a perspective view that schematically shows lamination members that form the honeycomb structure in accordance with one embodiment of the present invention, and FIG. 8B is a perspective view that shows a state in which the lamination members shown in FIG. 8A are laminated in the casing in accordance with one embodiment of the present invention so that a honeycomb structure is manufactured.

In a honeycomb structure 3, lamination members 35a are laminated, cells 31 being formed, and the most portion of the peripheral trimming loop of each of the lamination members (lamination face of the lamination members) is formed by an arc centered on one point within the cross section, and the rest of the peripheral trimming loop is formed by a line segment, whose distance from the center is different from the radius of the arc.

In the honeycomb structure 3 having the cut-out portion on the peripheral side face of the lamination member shown in FIGS. 7A and 7B, a cut-out portion 33 is formed on one portion of the peripheral trimming loop as the rest of the portion. Here, either one of the ends of each cell is sealed by the lamination member 35b for an end portion.

This cut-out portion 33 is a groove portion formed by laminating the lamination members 35a, which form the honeycomb structure 3, with the positions of cut-out portions 36a formed on the respective lamination members 35a adjusted to fit each other.

Since a protruding portion 38 for positioning, formed on the casing 103, which will be described later, may be inserted into the groove-shaped cut-out portion 33, the position of the cut-out portions of the respective lamination members 35a tends to be accurately adjusted.

Consequently, in a case where each of the lamination members 35a has been prepared in such a manner as to have the same positional relationship between the through hole 37a and the cut-out portion 36a formed therein, with one another, upon manufacturing each of the lamination members 35a, it may become easier to form cells 31 by aligning the positions of the cut-out portions 36a of the respective lamination members 35a to form a groove-shaped cut-out portion 33, and then inserting the protruding portion 38 for positioning formed on the casing 103 through the groove-shaped cut-out portion 33 to position all of the through holes 37a.

Here, the shape of the cut-out portion is not particularly limited, and any shape such as an almost semicircular shape, an almost triangular shape and an almost quadrilateral shape, may be used. Moreover, the size of the cut-out portion is not particularly limited, and any size may be used as long as, upon insertion of the protruding portion formed in the casing into the cut-out portion, it prevents the lamination members from rotating, as will be described later.

The casing 103 in accordance with the embodiments of the third aspect of the present invention, used for installing the honeycomb structure having the cut-out portion on the peripheral side face of the lamination member, is preferably formed into an almost cylindrical shape with the protruding portion 38 for positioning prepared in its cross-sectional shape, and preferably, the shape of the protruding portion 38 is formed into almost the same shape as the groove-shaped cut-out portion 33 formed by adjusting the position and stacking the cut-out portions 36a of the lamination members 35a to be laminated, and this shape preferably allows the insertion into the cut-out portion 33.

In the method for manufacturing the honeycomb structure having the cut-out portion on the peripheral side face of the lamination member in accordance with the embodiments of the fourth aspect of the present invention, in the lamination, first, on the end portion on the gas-inlet side, one to several sheets of the lamination members 35b for an end portion are laminated so as to be made in contact with the pressing member, with the position of the cut-out portion 36b of each lamination member 35b for an end portion and the position of the protruding portion 38 of the casing 103 adjusted to fit each other, and a predetermined number of the lamination members 35a are laminated thereon in such a manner as to insert the protruding portion 38a of the casing 103 into the groove-shaped cut-out portion 33 formed by stacking the cut-out portions 36a of the lamination members 35a while aligning the positions, and the lamination member 35b for an end portion is further laminated thereon, with the position of its cut-out portion 36b and the position of the protruding portion 38 of the casing 103 adjusted to fit each other.

Thereafter, the aggregated body of the lamination members is compressed so as to have a predetermined apparent density, and while the compressed state is being maintained, the pressing member is attached to the end portion on the gas-outlet side, and secured thereon. These processes make it possible to manufacture a honeycomb structure which keeps a predetermined lamination structure.

In the lamination of the method for manufacturing the honeycomb structure in accordance with the embodiments of the fourth aspect of the present invention, by fitting the protruding portion 38 of the casing into the groove-shaped cut-out portion 33 formed by stacking the cut-out portions 36 of the respective lamination members while aligning the positions, the respective lamination members are laminated so as to allow the corresponding through holes 37 to be superposed on one another.

In the method for manufacturing the honeycomb structure in accordance with the embodiments of the fourth aspect of the present invention, since the groove-shaped cut-out portions 33 formed by stacking the cut-out portions 36 of the respective lamination members are fixed in association with the shape of the protruding portion 38, the lamination members 35a tends to be prevented from rotating inside the casing so that an offset tends not to be caused in the positional relationship among the through holes 37a; therefore, it may become easier to surely manufacture the honeycomb structure in accordance with the embodiments of the first aspect of the present invention having a low pressure loss and no clogging of the cells.

Moreover, in the method for manufacturing the honeycomb structure in accordance with the embodiments of the fourth aspect of the present invention, since the position among the lamination members is adjusted by simply inserting the protruding portion 38 of the casing 103 into the groove-shaped cut-out portion 33 formed by stacking the cut-out portions 36 of the respective lamination members while aligning the positions, the time required for laminating the lamination members tends to be greatly shortened, and the honeycomb structure in accordance with the embodiments of the first aspect of the present invention tends to be manufactured with high working efficiency.

The structure, characteristics, materials and the like of the honeycomb structure having the cut-out portion on the peripheral side face of the lamination member as well as the casing and the method for manufacturing the honeycomb structure are the same as those of the honeycomb structure having the plane portion on the peripheral side face of the lamination member and the method for manufacturing the honeycomb structure, except that the cut-out portion is formed in place of the chord portion formed in the lamination members and the lamination member for an end portion, that the protruding portion is formed in place of the plane portion formed on the casing, and that the lamination is different; therefore, the description thereof will be omitted.

The following description will discuss the honeycomb structure having the cut-out portion on the peripheral side face of the lamination member with the cut-out filling member being inserted to fit into the cut-out portion among the honeycomb structures in accordance with the embodiments of the first aspect of the present invention. The description will also discuss the casing used for manufacturing the honeycomb structure and the method for manufacturing the honeycomb structure in accordance with the fourth aspect of the present invention.

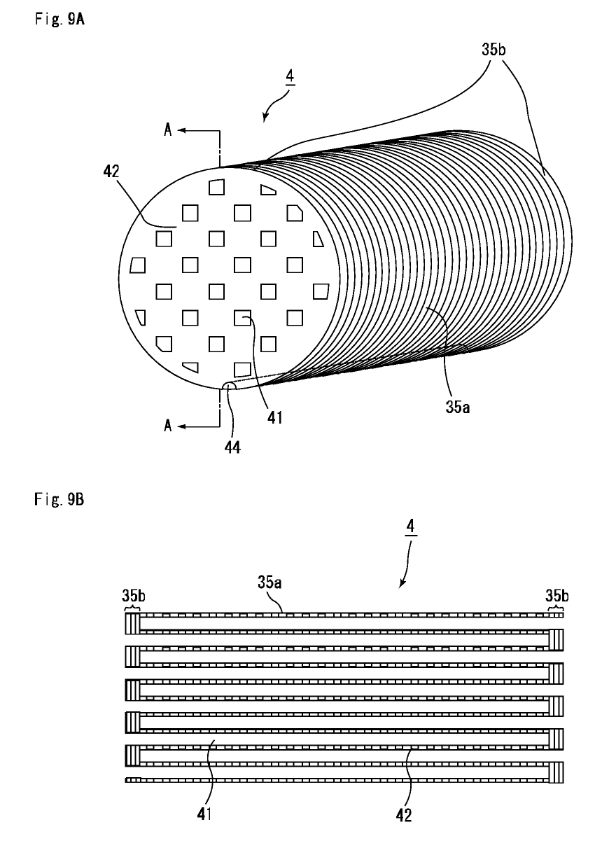

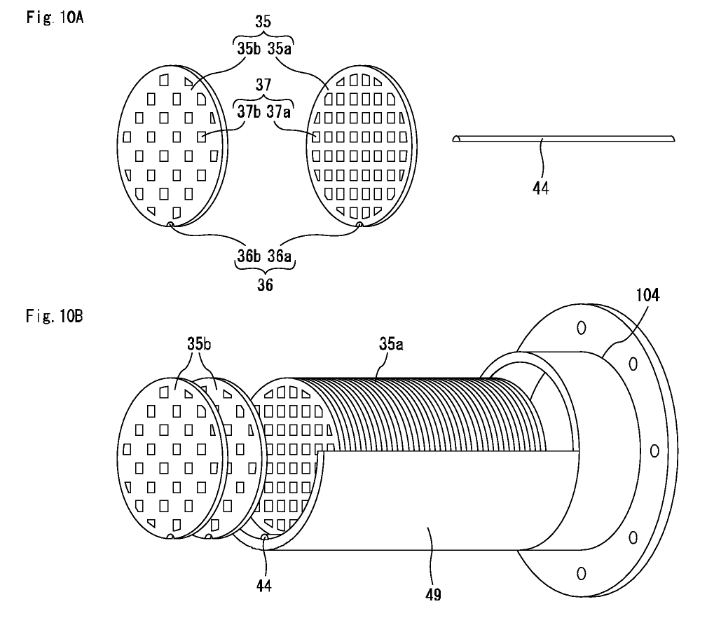

FIG. 9A is a perspective view that schematically shows one example of a honeycomb structure in accordance with one embodiment of the present invention, formed by lamination members each having an almost disc shape with a cut-out portion for positioning and a cut-out filling member, and FIG. 9B is a cross-sectional view taken along the line A-A of FIG. 9A. FIG. 10A is a perspective view that schematically shows a lamination member and a cut-out filling member that form the honeycomb structure in accordance with one embodiment of the present invention, and FIG. 10B is a perspective view that shows a state in which the lamination members shown in FIG. 10A are laminated in accordance with the cut-out filling member placed in the casing so that a honeycomb structure is manufactured.

The honeycomb structure 4 is configured by lamination members 35a, each having a cut-out portion 36a and a cut-out filling member 44 having almost the same cross-sectional shape as that of the cut-out portion, and the shape of the honeycomb structure on the cross section perpendicular to the cells is a round shape.

In the honeycomb structure 4, lamination members 35a are laminated, while aligning the positions of the cut-out portions 36a formed in the lamination members 35a, so that cells 41 are formed.

Here, either one of the ends of each cell is sealed by the lamination member 45b for an end portion.

This cut-out portion 36 is a portion that is provided for adjusting the position of through holes 37a to be formed in the respective lamination members, and when the lamination members 35a are laminated while aligning the positions of the cut-out portions, a groove-shaped portion can be formed.

Since the cut-out filling member 44 is fitted and inserted into this groove-shaped portion, the position of the cut-out portions of the respective lamination members 35a tends to be accurately adjusted.

Consequently, in a case where each of the lamination members 35a has been prepared in such a manner as to have the same positional relationship between the through hole 37a and the cut-out portion 36a formed therein, with one another, upon manufacturing each of the lamination members 35a, it may become easier to form cells 41 by aligning the positions of the cut-out portions 36a of the respective lamination members 35a to form a groove portion, and then inserting the cut-out filling member 44 through the groove portion to position all of the through holes 37a.

With respect to the material for the cut-out filling member, inorganic fibers or metal that are the same as the material to be used for the lamination members are preferably used. By using the same material as the lamination members, it may become easier to prevent a gap from occurring due to a difference in thermal expansion coefficients.

Moreover, the same material as the casing may also be used.

Here, the shape of the cut-out filling member is not particularly limited, and the shape may be any shape such as an almost semicircular shape, an almost triangular shape and an almost quadrilateral shape. Preferably, the shape is almost the same shape as that of the groove-shaped portion formed by laminating the lamination members 35a so that the positions of the cut-out portions 36a are aligned with one another, and can be fitted and inserted into the cut-out portions 36a. Moreover, the size of the cut-out filling member is not particularly limited, and the size may be any size as long as the lamination members do not rotate when the cut-out filling members are fitted to the cut-out portions of the lamination members.

Although not particularly limited, the casing 104 used for installing the honeycomb structure with the cut-out filling member being inserted to fit into the cut-out portion is preferably formed into a cylindrical shape, because this shape is desirably applicable to the installation of a cylindrical honeycomb structure.

In the method for manufacturing the honeycomb structure with the cut-out filling member being inserted to fit into the cut-out portion in accordance with the embodiments of the fourth aspect of the present invention, in the lamination, first, a cut-out filling member 44 having a shape corresponding to the cut-out portions 36a is placed in a casing 104 in which a honeycomb structure is installed.

Next, on the end portion on the gas-inlet side, one to several sheets of the lamination members 35b for an end portion are laminated so as to be made in contact with the pressing member, with the position of the cut-out portion 36b of each lamination member 35b for an end portion and the position of the cut-out filling member 44 placed in the casing 104 adjusted to fit each other, and a predetermined number of the lamination members 35a are laminated thereon in such a manner as to insert the cut-out filling member 44 into the groove portion formed by stacking the cut-out portions 36a of the lamination members 35a while aligning the positions, and the lamination member 35b for an end portion is further laminated thereon, with the position of its cut-out portion 36b and the position of the cut-out filling member 44 adjusted to fit each other.

Thereafter, the aggregated body of the lamination members is compressed so as to have a predetermined apparent density, and while the compressed state is being maintained, the pressing member is attached to the end portion on the gas-outlet side, and secured thereon. These processes make it possible to manufacture a honeycomb structure which keeps a predetermined lamination structure.

In the lamination of the method for manufacturing the honeycomb structure having the cut-out portion on the peripheral side face of the lamination member with the cut-out filling member being inserted to fit into the cut-out portion in accordance with the embodiments of the fourth aspect of the present invention, by inserting cut-out filling portion 44 into the groove portion formed by stacking the cut-out portions 36 of the respective lamination members while aligning the position, the respective lamination members are laminated so as to allow the corresponding through holes 37 to be superposed on one another.

In the method for manufacturing the honeycomb structure in accordance with the embodiments of the fourth aspect of the present invention, since the groove portions formed by stacking the cut-out portions 36 of the respective lamination members are fixed in association with the shape of the cut-out portions 44, the lamination members 35a tend to be prevented from rotating inside the casing so that an offset tends not to be caused in the positional relationship among the through holes 37a; therefore, it may become easier to surely manufacture the honeycomb structure in accordance with the embodiments of the first aspect of the present invention having a low pressure loss and no clogging of the cells.

Moreover, in the method for manufacturing the honeycomb structure in accordance with the embodiments of the fourth aspect of the present invention, since the position among the lamination members is adjusted by simply inserting the cut-out filling portion 44 into the groove portion formed by stacking the cut-out portions 36 of the respective lamination members while aligning the position, the time required for laminating the lamination members tends to be greatly shortened, and the honeycomb structure in accordance with the embodiments of the first aspect of the present invention tends to be manufactured with high working efficiency.

Furthermore, in the method for manufacturing the honeycomb structure in accordance with the fourth aspect of the present invention, the honeycomb structure in accordance with the first aspect of the present invention that has a true round shape in the cross-sectional shape perpendicular to the cells can be manufactured.

The other structure, characteristics, materials and the like of the honeycomb structure having the cut-out portion on the peripheral side face of the lamination member with the cut-out filling member being inserted to fit into the cut-out portion are the same as those of the honeycomb structure having the cut-out portion on the peripheral side face of the lamination member, therefore, the description thereof will be omitted.

With respect to the method for manufacturing the honeycomb structure having the cut-out portion on the peripheral side face of the lamination member with the cut-out filling member being inserted to fit into the cut-out portion, the same method as the method for manufacturing the honeycomb structure having the cut-out portion on the peripheral side face of the lamination member is used except that the cut-out filling member is preliminarily placed in the casing and that the respective lamination members are laminated, with the cut-out portion of the respective lamination members being fitted to the cut-out filling member, in place of using the casing having a protruding portion in the above-mentioned lamination; therefore, the description thereof will be omitted.

Next, the following description will discuss the honeycomb structure with the rod member being inserted in the cell formed by laminating the plurality of lamination members, the rod member penetrating from one of the ends to the other end of the cell, among the honeycomb structures in accordance with the embodiments of the first aspect of the present invention. The description will also discuss the casing used for manufacturing the honeycomb structure and the method for manufacturing the honeycomb structure in accordance with the fourth aspect of the present invention.

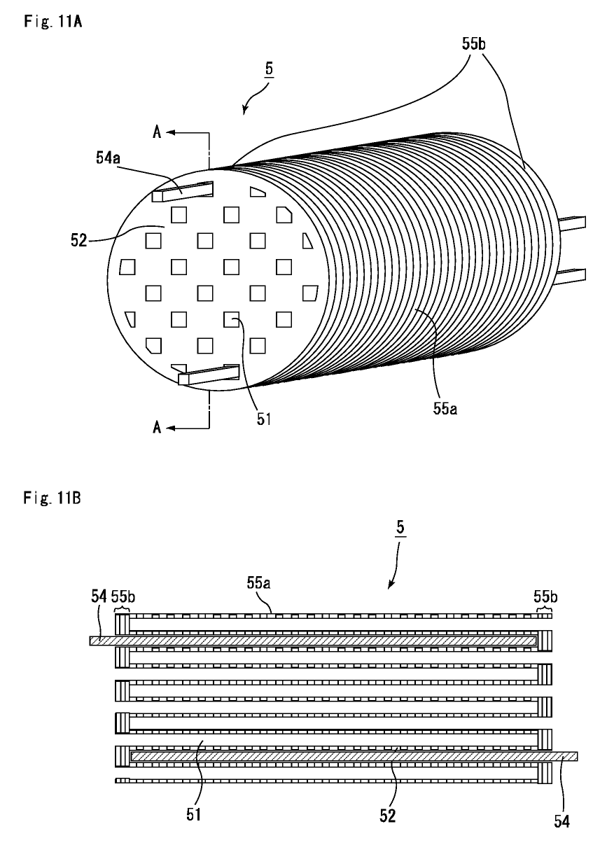

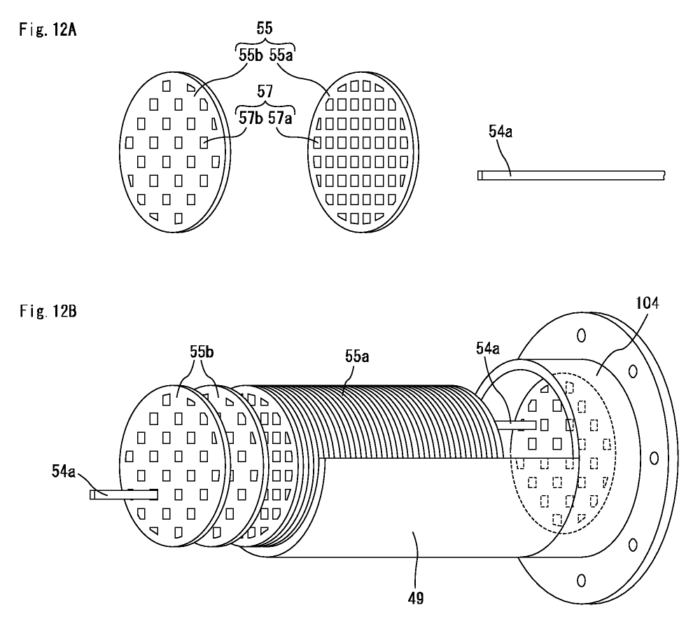

FIG. 11A is a perspective view that schematically shows one example of a honeycomb structure in accordance with one embodiment of the present invention, in which a rod member for positioning is inserted to one portion of the cells, and FIG. 11B is a cross-sectional view taken along the line A-A of FIG. 11A. FIG. 12A is a perspective view that schematically shows a lamination member that forms the honeycomb structure in accordance with one embodiment of the present invention and a rod member, and FIG. 12B is a perspective view that shows a state in which the lamination members are laminated while the rod member secured to a casing is simultaneously inserted through the through holes of the lamination members shown in FIG. 12A, so that a honeycomb structure is manufactured.

The honeycomb structure 5 includes lamination members 55a, each having a disc shape, laminated so that cells 51 are formed, and a rod member 54a inserted through the cell from one end to the other end thereof.

Here, either one of the end portions of the cells is sealed by a lamination member 55b for an end portion.

The honeycomb structure 5 is designed such that, by inserting the rod member 54a into the through hole 57a formed in the respective lamination members 55a, the positional relationship among the lamination members is fixed.

Therefore, upon manufacturing the respective lamination members 55a, by preliminarily forming the lamination members so as to allow the through holes formed in the respective lamination members to mutually have the same positional relationship, the positions of all the through holes 57a tend to be adjusted by inserting the rod member 54a through one or more of the through holes of the respective lamination members 55a, upon lamination of the lamination members, so that cells 57 tend to be formed.

The shape of the rod member is not particularly limited as long as it can be inserted through the through holes of the respective lamination members; however, the rod member preferably has a cross-sectional shape that is almost the same of the cross-sectional shape of the through holes, with the rod member that has been inserted through the through hole having a movable range as small as possible. This is because, when the movable range is made as small as possible, it may become easier to more accurately adjust the position of the respective through holes.

Although not particularly limited, in order to accurately fix the positional relationship among the respective lamination members, the greater the number of the rod members, the better, and two or more of them are preferably used.

With respect to the position through which the rod member is inserted, in a case where only one rod member is used, although not particularly limited, the position is preferably set to a position other than the center portion in the cross-sectional shape perpendicular to the longitudinal direction of the through holes in the lamination members. This is because, when the position is set in a position other than the center portion, the lamination members tends not to rotate centered on the rod member in the casing.

Moreover, in a case where a plurality of rod members are used, these are preferably arranged so as not to cause deviations in the relative positions of the rod members inside the lamination members.

With respect to the cells through which the rod member is inserted, the size thereof may be set to the same size as the other cells having no rod members inserted, or may be set to a different size. Moreover, the rod member may be inserted into one of cells that are regularly arranged, or a cell for allowing the rod member to be inserted therethrough may be prepared separately in addition to the cells that are regularly arranged.

The material for the rod member is preferably the same inorganic fibers or metal as the material used for the lamination members. The same material as that of the casing may also be used.

Moreover, the rod member may be prepared as an integral part with the casing that is integrally molded together with the casing.

Here, the rod member may be simply inserted through the cells, or may be bonded to the lamination members with an adhesive or the like.

Moreover, the gap between the cells and the rod member may be filled with a sealing material or the like.

The following description will discuss the method for manufacturing the honeycomb structure with the rod member being inserted in the cell.

The method for manufacturing the honeycomb structure with the rod member being inserted in the cell in accordance with the embodiments of the fourth aspect of the present invention includes adjusting the position in which, prior to the lamination, or simultaneously as the lamination, a rod member 54 is inserted through the through hole 57a of the lamination members, and with respect to a specific example of a series of processes, the following processes are proposed.

First, a rod member 54a is held in a casing 104 in which a honeycomb structure is placed by using an adhesive or the like. Here, the rod member 54a (see FIGS. 12A and 12B) means a rod-shaped member having a length equal to the length of the laminated lamination members.

Next, a lamination member 55b for an end portion is laminated while simultaneously inserting the rod member 54a into the through hole 57b of the lamination member 55b for an end portion, and successively, lamination members 55a are laminated while simultaneously inserting the rod member through the through holes 57a of the lamination members 55a.

Next, another rod member 54a is inserted into through holes 57a of the lamination members 55a located at a portion where no through hole of the preliminarily laminated lamination member 55b for an end portion is located.

Thereafter, a lamination member 55b for an end portion is laminated while simultaneously inserting the latterly inserted rod member 54a into through hole 57b of the lamination member 55b for an end portion, so that the positioning and the lamination are completed.

Moreover, by carrying out the above-mentioned series of processes outside the casing, a predetermined number of lamination members are laminated while the rod member 54a is inserted through the through holes 57 of the respective lamination members so that a lamination body, which allows the inserted rod member to be viewed from both of the sides, is formed, and the lamination body is then placed in the casing; thus, according to this method, it is also possible to carry out the positioning and the lamination.

Thereafter, the lamination body, formed by laminating the lamination members with the position of the through holes 57 adjusted, is compressed so as to provide predetermined apparent density, and then a pressing process is carried out on the lamination body, while maintaining the compressed state, so that the pressing member is attached and secured to the end portion on the gas-outlet side. These processes make it possible to manufacture a honeycomb structure in accordance with the embodiments of the first aspect of the present invention in which a predetermined lamination structure is maintained.

In the positioning and the lamination of the method for manufacturing the honeycomb structure with the rod member being inserted in the cell, by inserting the rod member 54 through the through holes 57 of the respective lamination members, it is possible to laminate the respective lamination members in such a manner as to allow the corresponding through holes 57 to be superposed on one another.

In the method for manufacturing the honeycomb structure in accordance with the embodiments of the fourth aspect of the present invention, since the rod member 54a is inserted through the through holes 57a formed in the respective lamination members 55a, the positional relationship among the respective lamination members is fixed so that the lamination members 55a tend to be prevented from rotating inside the casing, and an offset tends not to be caused in the positional relationship among the respective through holes 57a; therefore, it may become easier to surely manufacture the honeycomb structure in accordance with the embodiments of the first aspect of the present invention that has a low pressure loss and has no clogging of the cells.

Moreover, in the method for manufacturing the honeycomb structure in accordance with the embodiments of the fourth aspect of the present invention, since the position among the lamination members is adjusted by simply inserting the rod member 54a through the through holes 57a of the respective lamination members 55a, the time required for laminating the lamination members tends to be greatly shortened, and the honeycomb structure in accordance with the embodiments of the first aspect of the present invention tends to be manufactured with high working efficiency.

Furthermore, in the method for manufacturing the honeycomb structure in accordance with the embodiments of the fourth aspect of the present invention, the honeycomb structure in accordance with the embodiments of the first aspect of the present invention that has a true round shape in the cross-sectional shape perpendicular to the cells tends to be manufactured.

Next, the following description will discuss a method for manufacturing a honeycomb structure including removing of the rod member among the methods for manufacturing the honeycomb structure in accordance with the embodiments of the fourth aspect of the present invention.

In the method for manufacturing a honeycomb structure including removing of the rod member in accordance with the embodiments of the fourth aspect of the present invention, by carrying out the removing of the rod member that has been inserted into a predetermined through hole in the method for manufacturing the honeycomb structure with the rod member being inserted in the cell after the lamination members have been pressed inside the casing so that the position of each through hole is fixed, a honeycomb structure in which the mutual positions among the lamination members are accurately fixed, with all the through holes being opened, can be manufactured.

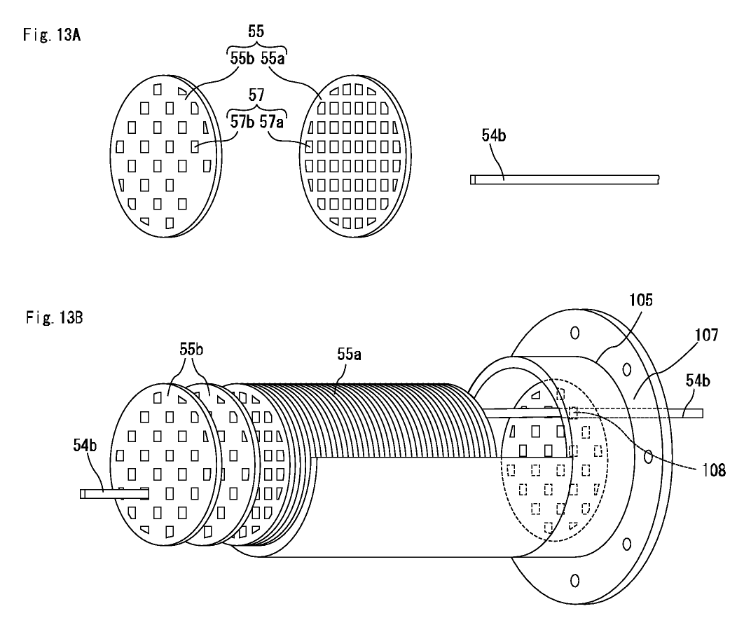

FIG. 13A is a perspective view that schematically shows lamination members and a rod member to be used for a method for manufacturing a honeycomb structure in accordance with one embodiment of the present invention, and FIG. 13B is a perspective view that shows a state in which the honeycomb structure is manufactured by laminating the lamination members while simultaneously inserting the rod member that penetrates a hole of a pressing member into through holes of the lamination members shown in FIG. 13A.

In this case (see FIG. 13B), a rod member 54b that is longer than the overall length of the casing is used as the rod member.

Moreover, with respect to the casing 105, a casing having a hole 108 that allows the rod member 54b to be inserted through a pressing member 107 is used.

In a case where this hole 108 is utilized, the rod member 54b tends to be drawn and removed from the honeycomb structure formed in such a manner that the positions of the through holes of the respective lamination members are mutually adjusted together with the rod member 54b serving as an integral part.

Here, the hole 108 is preferably formed into the same shape and located at the same position as those of one of the holes of the lamination member for an end portion that is made in contact with the pressing member 107. This is because, after removing the rod member, it may become easier to be allowed to communicate with the cells of the honeycomb structure to form one portion of the cells.

The following description will discuss a specific example of a series of processes of the above-mentioned manufacturing method.

First, the rod member 54b is preliminarily inserted through the hole 108 formed in one of the pressing members 107 of the casing 105 in which a honeycomb structure is placed, and held therein.

Next, a lamination member 55b for an end portion is laminated while simultaneously inserting the rod member 54b into the through hole 57b of the lamination member 55b for an end portion, and successively, lamination members 55a are laminated while simultaneously inserting the rod member through the through holes 57a of the lamination members 55a.

Next, another rod member 54b is inserted into through holes 57a of the lamination members 55a located at a portion where no through hole of the preliminarily laminated lamination member 55b for an end portion is located.

Thereafter, a lamination member 55b for an end portion is laminated while simultaneously inserting the latterly inserted rod member 54b into through hole 57b of the lamination member 55b for an end portion.

Lastly, the rod member 54b that has been inserted later is inserted through the hole 108 formed in one of the pressing members 107 of the casing 105 so that the positioning and the lamination are completed.

Moreover, by carrying out the above-mentioned series of processes outside the casing, a predetermined number of lamination members are laminated while the rod member 54b is inserted through the through holes 57 of the respective lamination members so that a lamination body is formed with the rod member 54b sticking out at the two ends thereof, and the lamination members are laminated in the casing, with the rod member 54b being inserted through the hole 108; thus, according to this method, it is also possible to carry out the positioning and the lamination.

The other pressing member, not shown, is attached to the casing after the positioning and the lamination, and at this time, the rod member 54b is also inserted through a hole formed in the pressing member.

Next, a pressing is carried out on the lamination members 55 with the rod member 54b being inserted through the lamination members 55 and the hole 108. The above-mentioned processes make it possible to manufacture a honeycomb structure in which a predetermined lamination structure is maintained.

Lastly, the rod members 54b are respectively drawn from the holes 108 on the two sides so that the rod member 54 is removed from the honeycomb structure. The above-mentioned method makes it possible to manufacture a honeycomb structure in which a predetermined lamination structure is maintained so that gases are allowed to flow through all the cells.

In the method for manufacturing the honeycomb structure including removing of the rod member in accordance with the embodiments of the fourth aspect of the present invention, since the rod member 54b can be removed through the holes 108 formed in the pressing members 107 of the casing after the pressing, it may become easier to surely manufacture the honeycomb structure in accordance with the embodiments of the first aspect of the present invention that has a true round shape in the cross-sectional shape perpendicular to the cells, and allows gases to flow through all the cells.

The structure, characteristics, materials and the like of the honeycomb structure with the rod member being inserted in the cell and the honeycomb structure manufactured through the manufacturing methods for the honeycomb structure including removing of the rod member are the same as those of the honeycomb structure with the cut-out filling member being inserted to fit into the cut-out portion, except that none of the cut-out portion and the cut-out filling member are prepared and that instead of these, the rod member is placed in one portion of the cells; therefore, the description thereof will be omitted.

With respect to the method for manufacturing a honeycomb structure with the rod member being inserted in the cell and the method for manufacturing the honeycomb structure including removing of the rod member, the same method as the method for manufacturing the honeycomb structure with the cut-out filling member being inserted to fit into the cut-out portion is used, except that, in the lamination, the rod member for positioning is inserted into the through holes of the lamination members so as to adjust the lamination members, in place of the processes in which, after a cut-out filling member has been preliminarily placed in the casing, the respective lamination members are laminated with the position of the cut-out portions of the respective lamination members being adjusted with the cut-out filling member that has been placed; therefore, the description thereof will be omitted.

Next, the following description will discuss the honeycomb structure in accordance with the embodiments of the second aspect of the present invention and the method for manufacturing the honeycomb structure in accordance with the embodiments of the fifth aspect of the present invention.

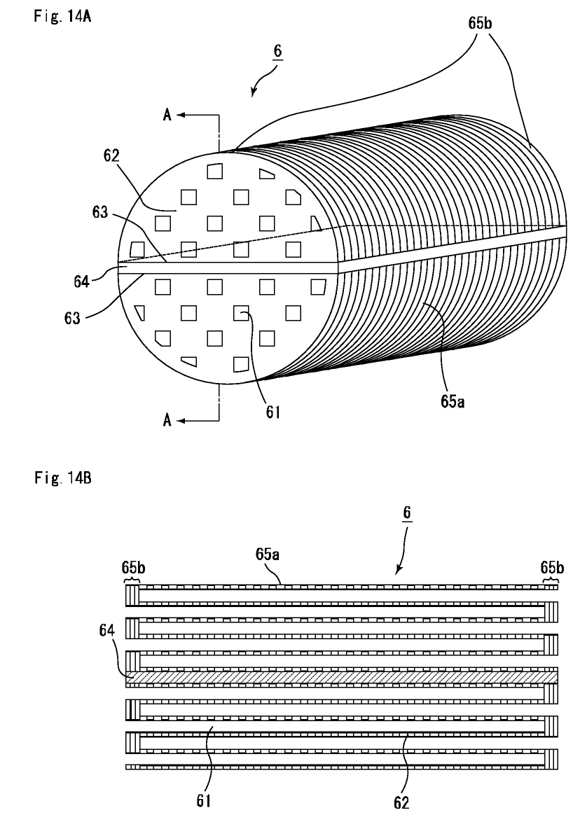

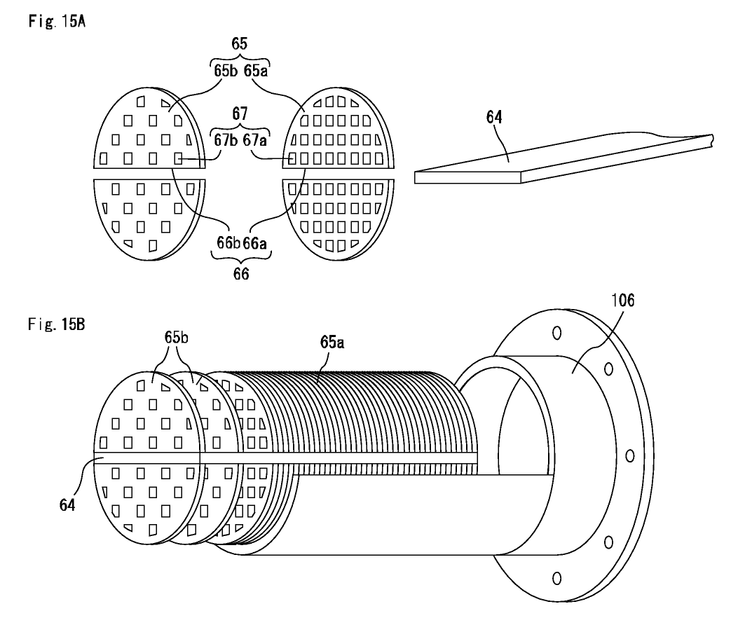

FIG. 14A is a perspective view that schematically shows one example of a honeycomb structure in accordance with one embodiment of the present invention that has the insertion member and the lamination members, each having a divided disc shape formed by dividing a round shape into two portions by the use of the insertion member, and FIG. 14B is a cross-sectional view taken along the line A-A of FIG. 14A. FIG. 15A is a perspective view that schematically shows the insertion member and the lamination members each having the divided disc shape formed by dividing a round shape into two portions by the insertion member, both of which form the honeycomb structure in accordance with one embodiment of the present invention, and FIG. 15B is a perspective view that shows a state in which the insertion member and the lamination members, shown in FIG. 15A, are laminated in the casing so that a honeycomb structure is manufactured.

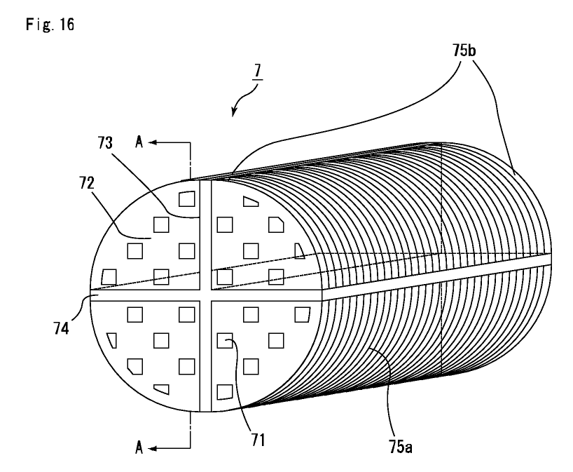

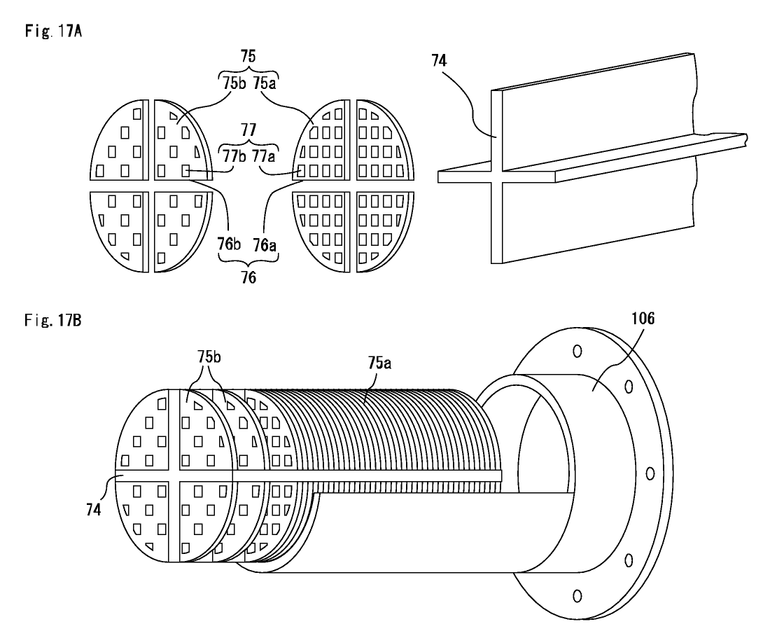

FIG. 16 is a perspective view that schematically shows one example of a honeycomb structure in accordance with one embodiment of the present invention that has an insertion member and lamination members each having a divided disc shape formed by dividing a round shape into four portions by the use of the insertion member. FIG. 17A is a perspective view that schematically shows the insertion member and the lamination members each having the divided disc shape formed by dividing a round shape into four portions by the insertion member, both of which form a honeycomb structure in accordance with one embodiment of the present invention, and FIG. 17B is a perspective view that shows a state in which the insertion member and a lamination members, shown in FIG. 17A, are laminated in a casing so that a honeycomb structure is manufactured.

Referring to FIGS. 14A, 14B, 15A and 15B, the following description will discuss the honeycomb structure of the embodiments of the second aspect of the present invention.

A honeycomb structure 6 in accordance with the embodiments of the second aspect of the present invention has an insertion member 64 and lamination members 65a that are laminated on and under the insertion member, and either one of the ends of each cell is sealed by a lamination member 65b for an end portion.

The insertion member 64, shown in FIGS. 14A, 14B, 15A and 15B, is a plate member that is formed in such a direction as to cut the cylindrical shape of the honeycomb structure 6 in parallel with the longitudinal direction of the cylindrical shape, and forms a continuous face extending from one of the ends of the cylindrical shape to the other end.

The lamination members 65, each having a divided disc shape formed by dividing a round shape by the insertion member 64, are laminated to form the honeycomb structure 6 in such a manner that side face plane portions 63 thereof are respectively made in contact with the upper portion and the lower portion of the insertion member 64.

The side face plane portion 63 is formed when the lamination members 65a are laminated, with side face plane portions 66a placed in the lamination members 65a that form the honeycomb structure 6 being mutually adjusted.

The side face plane portion 63 is a portion used for adjusting the position of the through holes 67a formed in the respective lamination members, and upon manufacturing the respective lamination members 65a, the lamination members are formed so that the through holes 67a formed in the respective lamination members and the side face plane portions 66a have the same positional relationship with each other; thus, by simply adjusting the positions of the side face plane portions 66a of the respective lamination members 65a upon lamination, the positions of all the through holes 67a tend to be adjusted.

The thickness of the insertion member 64 is not particularly limited.

Moreover, although not particularly limited, the material of the insertion member is preferably inorganic fibers or metal, that is, the same material as that of the lamination members. Here, the material of the insertion member may be the same material as those for the casing. Moreover, the insertion member may be prepared as an integral part with the casing that is, for example, integrally formed together with the casing.

The method for manufacturing the honeycomb structure in accordance with the embodiments of the fifth aspect of the present invention includes laminating the lamination members in such a manner that the side face plane portion forming the divided disc shape of each of the lamination members is made in contact with the insertion member.

With respect to the specific method used for making the side face plane portion in contact with the insertion member in the lamination, for example, the following method is used: the insertion member 64 is preliminarily fixed in a casing 106 in which a honeycomb structure is placed by using an adhesive or the like, and the lamination members 65a are laminated in the casing 106 with side face plane portions 66 being made in contact with the insertion member 64.

In the lamination of the method for manufacturing the honeycomb structure in accordance with the embodiments of the fifth aspect of the present invention, by laminating the lamination members with the side face plane portions 66 thereof being made in contact with the insertion member 64, the respective lamination members can be laminated so as to allow the corresponding through holes 67 to be superposed on one another.

In the method for manufacturing the honeycomb structure in accordance with the embodiments of the fifth aspect of the present invention, since the side face plane portions 66a are fixed in accordance with the shape of the insertion member 64, the lamination members 65a tends to be prevented from rotating inside the casing so that an offset tends not to be caused in the positional relationship among the through holes 67a; therefore, it may become easier to surely manufacture the honeycomb structure in accordance with the embodiments of the second aspect of the present invention that has a low pressure loss and has no clogging of the cells.

Moreover, in the method for manufacturing the honeycomb structure in accordance with the embodiments of the fifth aspect of the present invention, since the position among the lamination members can be adjusted by simply adjusting the side face plane portions 66a of the lamination members 65a and the insertion member 64, the time required for laminating the lamination members tends to be greatly shortened, and the honeycomb structure in accordance with the embodiments of the second aspect of the present invention tends to be manufactured with high working efficiency.

In addition to the above, the lamination member and the lamination member for an end portion used in the honeycomb structure in accordance with the embodiments of the second aspect of the present invention, and structure, characteristics, materials and the like of the honeycomb structure are the same as those of the honeycomb structure with the cut-out filling member inserted to fit into the cut-out portion in accordance with the embodiments of the first aspect of the present invention, except that the cut-out portion and the cut-out filling member are not included, and instead of these, the insertion member is included; therefore, the description thereof will be omitted.

Moreover, with respect to the method for manufacturing the honeycomb structure in accordance with the embodiments of the fifth aspect of the present invention, the same processes as those of the method for manufacturing the honeycomb structure with the cut-out filling member inserted to fit into the cut-out portion in accordance with the embodiments of the fourth aspect of the present invention described above are carried out except that, in the lamination, in place of the cut-out filling member, the insertion member is preliminarily placed in the casing, and that the respective lamination members are laminated, with the side face plane portions of the lamination members being fitted to the insertion member thus placed; therefore, the description thereof is omitted.

Here, the honeycomb structures shown in FIGS. 16, 17A and 17B, have the same structure as that of the honeycomb structure shown in FIGS. 14A, 14B, 15A and 15B, except that the shape of an insertion member 74 is designed into a shape formed by combining two insertion members 64 shown in FIG. 14A in the same longitudinal direction, and that lamination members 75a and 75b, each having a disc shape formed by dividing a round shape into four portions by the insertion member 74, are laminated; therefore, the description thereof is omitted.

The applications of the honeycomb structure in accordance with the embodiments of the present invention, or the honeycomb structure manufactured by the method for manufacturing the honeycomb structure in accordance with the embodiments of the present invention are not particularly limited, and may be, for example, exhaust-gas purifying apparatus for vehicles.

The following description will discuss an exhaust-gas purifying apparatus in which the honeycomb structure in accordance with the embodiments of the present invention, or the honeycomb structure manufactured by the method for manufacturing the honeycomb structure in accordance with the embodiments of the present invention is used.

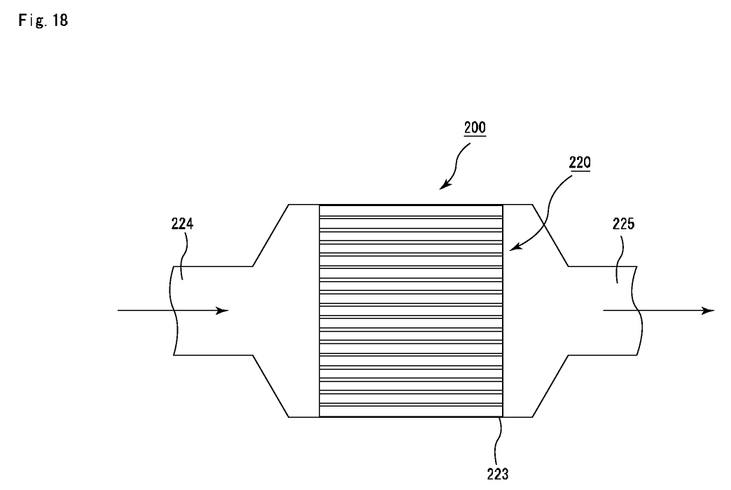

FIG. 18 is a cross-sectional view that schematically shows one example of an exhaust-gas purifying apparatus for a vehicle in which the honeycomb structure in accordance with the embodiments of the present invention, or the honeycomb structure manufactured by the method for manufacturing the honeycomb structure in accordance with the embodiments of the present invention is installed.

As shown in FIG. 18, an exhaust-gas purifying apparatus 200 has a structure in which: a casing 223 covers the outside of a honeycomb structure 220, and an introduction pipe 224 coupled to an internal combustion engine, such as an engine, is connected to the end portion on the side of the casing 223 to which exhaust gases are introduced, and an exhaust pipe 225 coupled to the outside is connected to the other end portion of the casing 223. Here, arrows in FIG. 18 indicate flows of the exhaust gases.

In the exhaust-gas purifying apparatus 200 having the above-mentioned structure, exhaust gases, discharged from the internal combustion engine such as an engine, are introduced into the casing 223 through the introduction pipe 224, and allowed to pass through the cell walls of the honeycomb structure 220, and after PMs have been captured by the cell walls to purify the exhaust gases, the purified gases are discharged outside through the exhaust pipe 25.

After PMs have been accumulated on the cell walls of the honeycomb structure 220, a regenerating is carried out on the honeycomb structure 220.

The regenerating of the honeycomb structure 220 means burning of the captured PMs, and with respect to the method of regenerating the honeycomb structure of the present invention, for example, a post-injection system, a system for burning the honeycomb structure by using a heating device installed on the exhaust-gas inlet side and the like may be used.

By carrying out the regenerating repeatedly, the exhaust-gas purifying function of the honeycomb structure can be maintained for a long time.

In the exhaust-gas purifying apparatus, since an offset tends not to occur in the positional relationship among the through holes of the laminated lamination members, the honeycomb structure, which has a low pressure loss and tends not to have an clogging of the cells, is installed, and therefore it may become easier to carry out the exhaust-gas purifying with high efficiency for a long time by using the above-mentioned system.

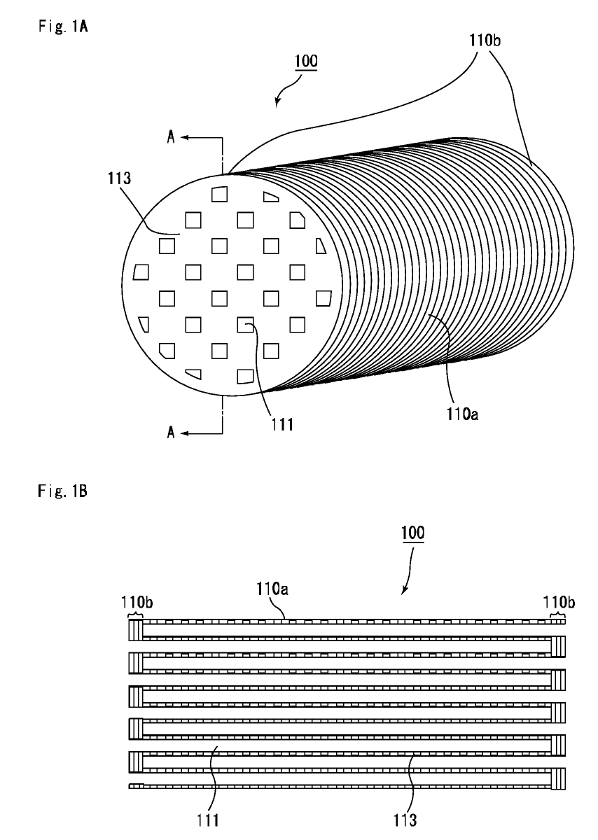

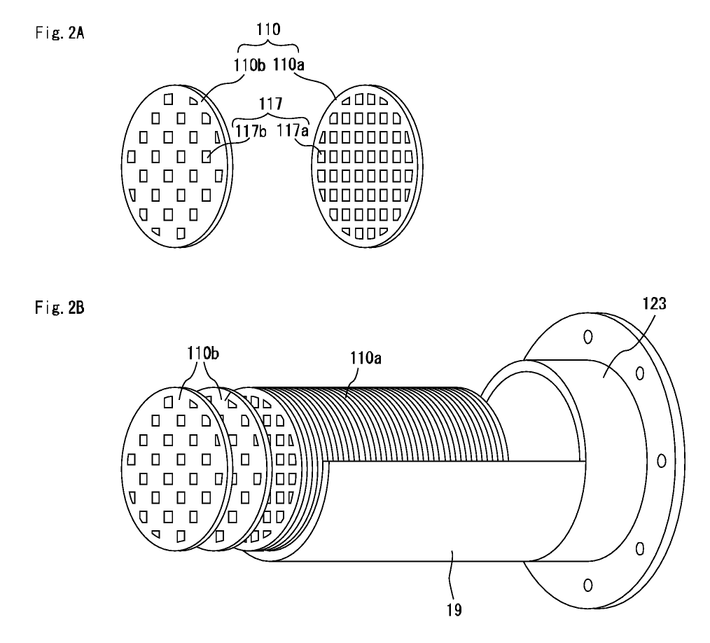

Here, in a conventional honeycomb structure (see FIGS. 1A and 2B), in order to form the honeycomb structure into a cylindrical shape, a lamination member 110 having a disc shape is manufactured, and the lamination members are laminated in a casing as described above.

In this case, in order to form cells, position of the respective through holes of the lamination members needs to be adjusted. When an offset occurs in the positions of the through holes, the cross-sectional area of one portion of the cells becomes smaller, and the gas passage becomes locally narrowed to cause an increase in pressure loss, and in the worst case, a problem of clogging occurs in the middle of a cell.

Here, since the disc-shaped lamination member can rotate inside the casing independently due to its shape, a positional offset among the through holes tends to occur. For this reason, upon laminating the lamination members, a careful operation is required so as not to cause an offset in the positions of the respective through holes, which makes this lamination to be inefficient.

Moreover, even when such a careful laminating operation is carried out, a positional offset in the respective through holes tends to occur due to vibrations or the like applied during a pressing after the lamination, with the result that an exhaust gas purifying apparatus using the honeycomb structure of this kind becomes a defective product.

The honeycomb structure in accordance with the embodiments of the present invention, or the honeycomb structure manufactured by the method for manufacturing the honeycomb structure in accordance with the embodiments of the present invention tend not to have an offset in the positional relationship among the through holes of each of the laminated lamination members after lamination, it may become easier to allow them to be the honeycomb structure which has a low pressure loss and tends not to have a clogging of the cells.

### EXAMPLES

The following description will discuss the present invention in more detail by use of Examples; however, the present invention is not intended to be limited only by these Examples.

### (I) Manufacturing of Lamination Members.

### (a) Manufacturing of Inorganic Fiber Lamination Members 15a (see FIGS. 4A and 4B).

### (1) Preparation for Sheet-Forming Slurry.

First, 50 parts by weight of alumina fibers, 50 parts by weight of glass fibers (average fiber diameter: 9 μm, average fiber length: 3 mm) and 10 parts by weight of an organic binder (polyvinyl alcohol-based fibers) were dispersed in a sufficient amount of water, and the mixture is sufficiently stirred to prepare sheet-forming slurry.

### (2) Sheet-Forming and Through-Hole Forming.

The slurry obtained in (1) was formed into a sheet by using a mesh having a shape in which a chord portion of 30 mm in length is formed on one portion of a round shape having a diameter of 143 mm, and the resulting product was dried at 135° C. so that a sheet-shaped inorganic composite having an almost disc shape was obtained.

Next, by carrying out a punching, through holes each having a size of 4.5 mm×4.5 mm were formed with intervals of 2 mm over the almost entire surface of the sheet-shaped inorganic composite having the almost disc shape.

### (3) Heat Treatment.

A heating was carried out on the sheet-shaped inorganic composite having an almost disc-shape obtained in (2) at 950° C. for one hour while applying pressure so that an inorganic fiber lamination member was obtained. Here, through the heating, alumina fibers were mutually fixed with one another through glass.

### (4) Oxidizing Treatment and Quenching Treatment.

Oxidizing treatment was carried out on the inorganic fiber lamination member obtained in (3) by immersing it in an HCl solution of 4 mol/l (liter) at 90° C. for one hour, and further a quenching treatment was carried out at 1050° C. for 5 hours.

Thus, an inorganic fiber lamination member 15a having a porosity of 90% and a thickness of 1 mm (aperture ratio: 37.5%) was manufactured.

### (b) Manufacturing of Inorganic Fiber Lamination Members 25a, 35a, 55a, 65a and 75a.

By changing the shape of the mesh used in the sheet-forming (2), the same manufacturing processes as those of the inorganic fiber lamination member 15a were carried out to manufacture the following lamination members having the respective shapes shown in Table 1: a lamination member 25a having a protruding portion (see FIG. 6A), a lamination member 35a having a cut-out portion (see FIG. 8A), a disc-shaped lamination member 55a (see FIG. 12A), a lamination member 65a having a divided disc shape formed by dividing a disc into two portions (see FIG. 15A) and a lamination member 75a having a divided disc shape formed by dividing a disc into four portions (see FIG. 17A).

TABLE 1

| | Lamination member | |
|---|---|---|
| Lamination member | for an end portion | Shape |
| Lamination member 15a | Lamination member | Almost disc shape having a diameter of 143 mm |
| | 15b for an end portion | with a chord portion having a length of 30 mm |
| Lamination member 25a | Lamination member | Almost disc shape having a diameter of 143 mm |
| | 25b for an end portion | with a semicircular shape having a diameter of 5 mm |
| | | on the peripheral portion |
| Lamination member 35a | Lamination member | Almost disc shape having a diameter of 143 mm |
| | 35b for an end portion | with a semicircular shaped cut-out portion |
| | | having a diameter of 7 mm on the peripheral |
| | | portion |
| Lamination member 55a | Lamination member | Disc shape having a diameter of 143 mm |
| | 55b for an end portion | |
| Lamination member 65a | Lamination member | Divided disc shape formed by dividing a disc |
| | 65b for an end portion | having a diameter of 143 mm into two portions |
| Lamination member 75a | Lamination member | Divided disc shape formed by dividing a disc |
| | 75b for an end portion | having a diameter of 143 mm into four portions |

### (II) Manufacturing of Lamination Member for an End Portion (Metal Plate Member).

### (a) Manufacturing of Lamination Member 15b for an End Portion.

A metal plate including Ni—Cr alloy had been machined into a shape in which a round shape having a diameter of 143 mm was provided with a chord portion having a length of 30 mm, and a laser machining was carried out on the resulting product so as to manufacture a lamination member 15b for an end portion (metal plate member) having an almost disc shape in which holes of 4.5 mm×4.5 mm were formed in a grid pattern.

(b) Manufacturing of Lamination Members 25b, 35b, 55b, 65b and 75b for an end portion.

By changing the machined shape of the metal plate, the same manufacturing processes as those of the lamination member 15b for an end portion were carried out so that the following lamination members having the respective shapes shown in Table 1 were manufactured: a lamination member 25b having a protruding portion (see FIG. 6A), a lamination member 35b having a cut-out portion (see FIG. 8A), a disc-shaped lamination member 55b (see FIG. 12A), a lamination member 65b having a divided disc shape formed by dividing a disc into two portions (see FIG. 15A)and a lamination member 75b having a divided disc shape formed by dividing a disc into four portions (see FIG. 17A).

Here, since the peripheral shape of each of the lamination members 15b, 25b, 35b, 55b, 65b and 75b for an end portion is the same as that of each of the lamination members 15a, 25a, 35a, 55a, 65a and 75a and the through holes are formed in a grid pattern, the cell density thereof is almost half of that of each of the lamination members 15a, 25a, 35a, 55a, 65a and 75a.

### (III) Supporting of Catalyst on Lamination Member.

First, LaCoO3 was supported on each of the lamination members of the respective kinds as an oxide catalyst. In this method, into an ethanol solvent were added 0.01 mol of La(NO3)3.6H2O, 0.01 mol of Co(OCOCH3)2.4H2O and 0.024 mol of C6H8O7.H2O (citric acid) at a rate of 20 ml, and then stirred to prepare a LaCoO3 precursor sol. Each of the lamination members of the respective kinds was immersed in this sol, and after having been taken out, the excessive sol was removed through suction, and the resulting lamination member was dried at 100° C., and then a firing was carried out at 600° C. for one hour.

Here, a perovskite structure of LaCoO3 was confirmed through an X-ray diffraction measurement.

By using the above-mentioned lamination members having the catalyst supported thereon, a honeycomb structure was manufactured.

### (IV) Manufacturing of a Casing.

### (a) Manufacturing of a Casing 101 (see FIG. 4B).

As a casing for installing the lamination members of the respective kinds, through a metal machining was manufactured a cylindrical shaped casing 101 (can-type) having, in its cross section perpendicular to the longitudinal direction of the cylinder portion, an almost round shape of an inner diameter of 145 mm with a chord portion of a length of 32 mm formed therein, in which the chord portion forms a plane portion having a size of 32 mm×70 cm on the inner peripheral face of the cylinder, as shown in FIG. 4B.

### (b) Manufacturing of Casings 102 to 106.

By changing the machined shape in the metal machining, the following casings, each having a cross-sectional shape perpendicular to the longitudinal direction of the cylinder portion as shown in Table 2, were manufactured: a casings 102 having a groove portion (see FIG. 6B), a casing 103 having a protruding portion (see FIG. 8B), a casing 104 having a can-type shape (see FIG. 10B), a casing 105 having a can-type shape with through holes formed in a pressing member (see FIG. 12B) and casings 106 having a can-type shape with different inner diameters in the round shape (see FIGS. 15B and 17B).

TABLE 2

| | Cross-sectional shape in a direction vertical to the longitudinal direction |
|---|---|
| Casing | of the cylinder portion |
| Casing 101 | Almost round shape having an inner diameter of 146 mm with a chord |
| | portion having a length of 32 mm |
| Casing 102 | Almost round shape having a diameter of 145 mm having a groove |
| | portion in a semicircular shape having a diameter of 7 mm on the |
| | peripheral portion |
| Casing 103 | Almost round shape having a diameter of 145 mm having a protruding |
| | portion in a semicircular shape having a diameter of 6 mm on the |
| | peripheral portion |
| Casing 104 | Round shape having a diameter of 145 mm |
| Casing 105 | Round shape having a diameter of 145 mm (with a through hole formed in |
| | the pressing member) |
| Casing 106 | Round shape having a diameter of 147 mm |

### (V) Manufacturing of a Cut-Out Filling Member 44 (see FIGS. 10A and 10B).

By machining the same material as that used for manufacturing the casing, a cut-out filling member 44 (see FIGS. 10A and 10B having a semicircular shape of 5 mm in diameter in the perpendicular cross-sectional shape with a length of 70 cm was manufactured.

### (VI) Manufacturing of Rod Members 54a and 54b.

By machining the same material as that used for manufacturing the casing, a rod member 54a having a size of 4.2 mm×4.2 mm×70 cm and a rod member 54b having a size of 4.2×4.2 mm×100 cm were manufactured.

### (VII) Manufacturing of Insertion Members 64 and 74.

(a) By machining the same material as that used for manufacturing the casing, an insertion member 64 having a rectangular parallelepiped shape of 70 cm×143.0 mm×3.0 mm was manufactured.

(b) In the same manner as in the above (a), an insertion member 74 having a shape of two rectangular parallelepiped shapes (cross shape), each having a size of 70 cm×146.0 mm×3.0 mm, combined perpendicularly with each other in such a manner that, in its cross-sectional shape perpendicular to the longitudinal direction, the intersecting point of diagonal lines of one of the two rectangular shapes, each having a size of 146 cm×3.0 mm, corresponds to that of the other rectangular shape.

### Example 1

### see FIGS. 4A and 4B

First, the metal casing 101 (can-type metal container), which was obtained through (IV), having the pressing member attached on the gas-inlet side thereof, was vertically placed with the side to which the member had been attached facing down. Moreover, after one sheet of the lamination member a (metal plate member) for an end portion obtained in (II) had been placed, with the plane portion of the casing 101 and the chord portion of the lamination member 15b for an end portion being adjusted, 105 sheets of the inorganic fiber lamination members 15a obtained in (I) were laminated (lamination length: 105 mm) with the position of the plane portion of the casing 101 and the chord portion of each of the lamination members 15a being adjusted, and lastly, one sheet of the lamination member 15b for an end portion was laminated with the plane portion of the casing 101 and the chord portion of the lamination member 15b for an end portion being adjusted; thereafter, the pressing member was also placed on the gas-outlet side so that pressing and fixing were carried out to manufacture a honeycomb structure having an overall lamination length of 70 mm.

By repeating this method, ten samples of honeycomb structures were manufactured.

### Example 2

### see FIGS. 6A and 6B

By using the metal casing 102, the lamination members 25b for an end portion and the inorganic fiber lamination members 25a, and by adjusting the position of the groove portion of the casing 102 and the position of the protruding portion of each of the lamination member to fix each other, basically the same lamination as those of Example 1 were carried out; thus, ten samples of honeycomb structures were manufactured.

### Example 3

### see FIGS. 8A and 8B

By using the metal casing 103, the lamination members 35b for an end portion and the inorganic fiber lamination members 35a, and by inserting the protruding portion of the casing 103 into the groove-shaped cut-out portion formed by stacking the cut-out portions of the respective lamination members so as to adjust the position, basically the same lamination as those of Example 1 were carried out; thus, ten samples of honeycomb structures were manufactured.

### Example 4

### see FIGS. 10A and 10B

By using the metal casing 104, the lamination members 35b for an end portion, the inorganic fiber lamination members 35a and the cut-out filling member 44, after fixing the cut-out filling member 44 on the inner periphery of the casing 104 by an adhesive, by inserting the cut-out filling member 44 into the groove portion formed by stacking the cut-out portions of the respective lamination members so as to adjust the position, basically the same lamination as those of Example 1 were carried out; thus, ten samples of honeycomb structures were manufactured.

### Example 5

### see FIGS. 12A and 12B

A metal casing 104, lamination members 55b for an end portion, inorganic fiber lamination members 55a and rod members 54a were used, and the rod members 54a were respectively inserted into through holes at two positions located on the periphery of the lamination members 55b for an end portion that opposed to each other with the center of the round shape in the middle.

Next, 105 sheets of the inorganic fiber lamination members 55a were laminated while simultaneously inserting the rod members into the through holes of the inorganic fiber lamination members 55a.

Thereafter, rod members 54a were respectively inserted into through holes at two positions located on the periphery of the inorganic fiber lamination members 55a that had no through holes in the previously laminated lamination member 55b for an end portion, and had equal distances from the previously inserted rod members 54a.

Lastly, while the rod members 54a that had been inserted later were inserted into through holes of other lamination members 55b for an end portion, the lamination members 55b for an end portion were laminated so that a lamination body where the two inserted rod members 54a were viewed from the two ends was formed.

This lamination body was placed on the inner circumferential portion of the metal casing 104, and secured therein through the same processes as those of Example 1; thus, ten samples of honeycomb structures were manufactured.

### Example 6

### see FIGS. 13A and 13B

A metal casing 105, lamination members 55b for an end portion, inorganic fiber lamination members 55a and rod members 54b were used, and the same lamination as those of Example 5 were carried out so that a lamination body with the two inserted rod members 54b sticking out from the two ends was formed.

The lamination body was installed in the casing 105 by inserting one of the ends of the rod members sticking out from the lamination body through a hole formed in a pressing member on the gas-inlet side, and the other end of each of the rod members was inserted through a hole formed in a pressing member on the gas-outlet side so that the pressing member was attached, and then secured by applying pressure.

Thereafter, the rod members 54b sticking out from the pressing members on the two ends were drawn and removed; thus, ten samples of honeycomb structures were manufactured.

### Example 7

### see FIGS. 15A and 15B

A metal casing 106, lamination members 65b for an end portion, inorganic fiber lamination members 65a and an insertion member 64 were used, and the metal casing 106 having a pressing member attached on the gas-inlet side thereof was vertically placed with the side to which the member had been attached facing down, and the insertion member 64 was vertically placed in the inner peripheral portion.

Next, the lamination members 65b for an end portion, the inorganic fiber lamination members 65a and the lamination members 65b for an end portion were respectively laminated on semi-cylindrical shaped areas separated by the insertion member 64, and secured through the same processes as those of Example 1; thus, ten samples of honeycomb structures were manufactured.

### Example 8

### see FIGS. 17A and 17B

A metal casing 106, lamination members 75b for an end portion and an insertion member 74a were used, and ten samples of honeycomb structures were manufactured through the same processes as those of Example 7.

### Comparative Example 1

### see FIGS. 2A and 2B

A metal casing 104, lamination members 55b for an end portion and inorganic fiber lamination members 55a were used, and in the metal casing 104 placed vertically, with the side to which the member had been attached facing down, one sheet of the lamination member 55b for an end portion, 105 sheets of the inorganic fiber lamination members 55a and one sheet of the lamination member 55b for an end portion were laminated, while visual attention was being paid so that the positions of the through holes of the respective lamination members were fitted to one another. Thereafter, the pressing members were attached, and press-secured thereon so that ten samples of honeycomb structures having an overall lamination length of 70 mm were manufactured.

### (Evaluation)

### Measurements of Initial Pressure Loss.

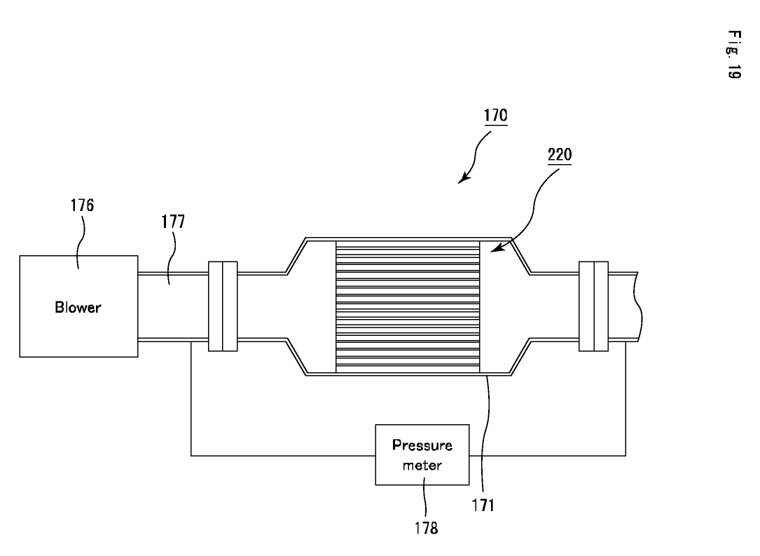

A pressure loss measuring apparatus 170 as shown in FIG. 19 was used for the measurement. FIG. 19 is an explanatory drawing that shows the pressure loss measuring apparatus.

This pressure loss measuring apparatus 170 has a structure in which a honeycomb structure 220, fixed in a metal casing 171, is placed in an exhaust gas pipe 177 of a blower 176, and a pressure meter 178 is attached so as to detect pressures of the honeycomb structure 220 before and after the flow of exhaust gases.

Here, the blower 176 was driven so that the flow rate of exhaust gases was set to 750 m3/h, and after a lapse of 5 minutes from the start of the driving operation, a pressure difference (pressure loss) was measured.

The above-mentioned measurements were carried out on each of the ten samples of honeycomb structures manufactured in Examples 1 to 8 and Comparative Example 1, and the average value, maximum value and minimum value of the ten samples of pressure losses were compared with one another.

The results are as shown in Table 3.

TABLE 3

| | | | Lamination | | | Pressure loss (kPa) | | |
|---|---|---|---|---|---|---|---|---|
| | Reference | Lamination | member for end | | Other | Average | Max. | Min. |
| | Figure | member | portion | Casing | members | value | value | value |
| Example 1 | FIG. 4A, 4B | Lamination | lamination | Casing | No | 13.8 | 13.9 | 13.7 |
| | | member | member 15b for | 101 | | | | |
| | | 15a | end portion | | | | | |
| Example 2 | FIG. 6A, 6B | Lamination | lamination | Casing | No | 13.3 | 13.4 | 13.2 |
| | | member | member 25b for | 102 | | | | |
| | | 25a | end portion | | | | | |
| Example 3 | FIG. 8A, 8B | Lamination | lamination | Casing | No | 13.5 | 13.7 | 13.4 |
| | | member | member 35b for | 103 | | | | |
| | | 35a | end portion | | | | | |
| Example 4 | FIG. 10A, | Lamination | lamination | Casing | Cut-out | 13.6 | 13.9 | 13.4 |
| | 10B | member | member 35b for | 104 | filling | | | |
| | | 35a | end portion | | member | | | |
| | | | | | 44 | | | |
| Example 5 | FIG. 12A, | Lamination | lamination | Casing | Rod | 13.7 | 13.9 | 13.6 |
| | 12B | member | member 55b for | 104 | member | | | |
| | | 55a | end portion | | 54a | | | |
| Example 6 | FIG. 13A, | Lamination | lamination | Casing | Rod | 13.4 | 13.6 | 13.2 |
| | 13B | member | member 55b for | 105 | member | | | |
| | | 55a | end portion | | 54b | | | |
| Example 7 | FIG. 15A, | Lamination | lamination | Casing | Insertion | 14.1 | 14.3 | 14.0 |
| | 15B | member | member 65b for | 106 | member | | | |
| | | 65a | end portion | | 64 | | | |
| Example 8 | FIG. 17A, | Lamination | lamination | Casing | Insertion | 14.3 | 14.4 | 14.2 |
| | 17B | member | member 75b for | 106 | member | | | |
| | | 75a | end portion | | 74 | | | |
| Comparative | FIG. 2A, 2B | Lamination | lamination | Casing | No | 17.8 | 21.2 | 14.0 |
| Example 1 | | member | member 55b for | 104 | | | | |
| | | 55a | end portion | | | | | |

As shown in Table 3, with respect to the honeycomb structures according to Examples 1 to 8, the average value of the initial pressure losses was low, and in particular, the maximum value was low. This indicates that a defective product having an extremely high pressure loss due to clogged cells tend not to be generated, and a honeycomb structure having low pressure loss tends to be surely manufactured.

In contrast, with regard to the honeycomb structure of the Comparative Example 1, in comparison with the honeycomb structures according to the Examples, although no difference was found in the minimum value, the average value was slightly high, and the maximum value was particularly high.

This indicates that the honeycomb structure according to the Comparative Example causes high deviations in the quality, and in particular, the honeycomb structure with a high pressure loss is considered to have a narrowed gas passage due to clogging in most of the cells, and a honeycomb structure of this type tends to be not suitable as an exhaust-gas purifying filter.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed as new and desired to be secured by Letters Patent of the United States is:

1. A pillar-shaped honeycomb structure comprising a plurality of lamination members laminated together and having a plurality of through holes, the plurality of through holes forming a plurality of cells,
wherein said plurality of lamination members are substantially disc shaped, and
wherein:
said plurality of lamination members have a peripheral side face having a plane portion, a protruding portion, or a cut-out portion, or
a rod member is inserted in at least one cell of said plurality of cells, said rod member penetrating from one end of the at least one cell to another end of said the at least one cell.

2. The honeycomb structure according to claim 1, wherein said plurality of lamination members have the peripheral side face having the cut-out portion and are laminated so that said cut-out portions are laminated with one another, and
wherein a cut-out filling member having substantially the same shape as that of the laminated cut-out portions is inserted to fit into the laminated cut-out portions.

3. The honeycomb structure according to claim 1, wherein said plurality of lamination members comprise at least one of a lamination member mainly comprising inorganic fibers and a lamination member mainly comprising metal.

4. The honeycomb structure according to claim 3, wherein a material for said lamination member mainly comprising inorganic fibers is silica-alumina, mullite, alumina, silica, titania, zirconia, silicon nitride, boron nitride, silicon carbide, or basalt.

5. The honeycomb structure according to claim 3, wherein said inorganic fibers are firmly fixed with one another by an inorganic substance containing silica in said lamination member mainly comprising inorganic fibers.

6. The honeycomb structure according to claim 5, wherein said inorganic fibers are firmly fixed with one another at crossing points of said inorganic fibers or neighborhood of the points.

7. The honeycomb structure according to claim 3, wherein a material for said lamination member mainly comprising metal is chrome-based stainless steel or chrome-nickel-based stainless steel.

8. The honeycomb structure according to claim 3, wherein a lamination member for an end portion having through holes formed in a grid pattern is laminated onto each of two ends of at least one of said lamination member mainly comprising inorganic fibers and said lamination member mainly comprising metal.

9. The honeycomb structure according to claim 1, wherein a catalyst is supported on said lamination member.

10. The honeycomb structure according to claim 1, wherein said protruding portion or said cut-out portion has a substantially semicircular shape, a substantially triangular shape or a substantially quadrilateral shape.

11. A honeycomb structure comprising:
a cylindrical lamination body formed by laminating a plurality of lamination members each having a plurality of through holes; and
an insertion member placed in parallel with a longitudinal direction of the cylindrical lamination body so as to divide said cylindrical lamination body,
wherein said plurality of lamination members have a same divided disc shape as a cross section perpendicular to the longitudinal direction of the cylindrical lamination body that is divided by said insertion member,
wherein a side face plane portion of said laminated lamination members is placed so as to contact said insertion member, and
wherein said plurality of through holes are connected to one another to form a plurality of cells.

12. The honeycomb structure according to claim 11, wherein said plurality of lamination members comprise at least one of a lamination member mainly comprising inorganic fibers and a lamination member mainly comprising metal.

13. The honeycomb structure according to claim 12, wherein a material for said lamination member mainly comprising inorganic fibers is silica-alumina, mullite, alumina, silica, titania, zirconia, silicon nitride, boron nitride, silicon carbide, or basalt.

14. The honeycomb structure according to claim 12, wherein said inorganic fibers are firmly fixed with one another by an inorganic substance containing silica in said lamination member mainly comprising inorganic fibers.

15. The honeycomb structure according to claim 14, wherein said inorganic fibers are firmly fixed with one another at crossing points of said inorganic fibers or neighborhood of the points.

16. The honeycomb structure according to claim 12, wherein a material for said lamination member mainly comprising metal is chrome-based stainless steel or chrome-nickel-based stainless steel.

17. The honeycomb structure according to claim 12, wherein a lamination member for an end portion having through holes formed in a grid pattern is laminated onto each of two ends of at least one of said lamination member mainly comprising inorganic fibers and said lamination member mainly comprising metal.

18. The honeycomb structure according to claim 11, wherein a catalyst is supported on said lamination member.

19. A casing for an exhaust-gas purifying apparatus used for covering a honeycomb structure formed of a plurality of lamination members, said casing comprising:
a casing body configured to receive the plurality of lamination members; and
a plane portion, a groove portion, or a protruding portion formed on said casing body at a region where said the plurality of lamination members are laminated.

20. The casing according to claim 19, wherein said groove portion or said protruding portion has a substantially semicircular shape, a substantially triangular shape, or a substantially quadrilateral shape.

21. A method for manufacturing a honeycomb structure, said method comprising:
laminating a plurality of lamination members so that a plane portion formed on a peripheral side face of said lamination members is mounted on a plane portion formed on a casing;
laminating a plurality of lamination members so that a protruding portion formed in a peripheral side face of said lamination members is fitted into a groove portion formed in a casing;
laminating a plurality of lamination members so that a cut-out portion formed in a peripheral side face of said lamination members is fitted to a protruding portion formed in a casing;
laminating a plurality of lamination members in a manner so as to allow a cut-out filling member to be inserted to fit into a cut-out portions formed in a peripheral side face of said lamination members; or
adjusting a position of through holes by inserting a rod member into at least one of said through holes before or after laminating lamination members.

22. The method for manufacturing a honeycomb structure which comprises adjusting a position of through holes by inserting a rod member into at least one of said through holes before or after laminating said lamination members according to claim 21, further comprising:
applying a pressure onto said lamination members in which said rod member has been inserted in said through hole in said casing so that the position of said through holes is fixed to form cells; and
pulling out said rod member from said cell formed in said applying of pressure so as to be removed.

23. A method for manufacturing a honeycomb structure, said method comprising:
laminating lamination members, each lamination member having a same divided disc shape as a cross section of a cylindrical lamination body perpendicular to a longitudinal direction of said cylindrical lamination body divided by a insertion member,
said lamination members being laminated in a manner as to allow a side face plane portion of said lamination members to contact to said insertion member.

24. The method for manufacturing a honeycomb structure according to claim 21, wherein said lamination member is a lamination member mainly comprising inorganic fibers, manufactured by:
forming a sheet-forming slurry into a sheet to manufacture an inorganic fiber aggregated body;
drying said inorganic fiber aggregated body;
punching said inorganic fiber aggregated body to form through holes with equal intervals over substantially the entire surface; and
heating said inorganic fiber aggregated body at a temperature of at least about 900° C. and at most about 1050° C.

25. The method for manufacturing the honeycomb structure according to claim 23, wherein said lamination member is a lamination member mainly comprising inorganic fibers, manufactured by:
forming a sheet-forming slurry into a sheet to manufacture an inorganic fiber aggregated body;
drying said inorganic fiber aggregated body;
punching said inorganic fiber aggregated body to form through holes with equal intervals over substantially the entire surface; and
heating said inorganic fiber aggregated body at a temperature of at least about 900° C. and at most about 1050° C.
